(19) United States
(12) Patent Application Publication
(10) Pub. No.: US 2025/0151078 A1
(43) Pub. Date: May 8, 2025

(54) TWO-STAGE L1 CONTROL INFORMATION

(71) Applicant: Samsung Electronics Co., Ltd., Suwon-si (KR)

(72) Inventors: Emad Nader Farag, Flanders, NJ (US); Eko Onggosanusi, Coppell, TX (US)

(21) Appl. No.: 18/920,799

(22) Filed: Oct. 18, 2024

Related U.S. Application Data
(60) Provisional application No. 63/547,261, filed on Nov. 3, 2023.
(60) Provisional application No. 63/601,597, filed on Nov. 21, 2023.

(51) Int. Cl. H04W 72/231; H04L 5/00; H04W 72/0453; H04W 72/0457; H04W 76/20

(52) U.S. Cl. CPC H04W 72/231; H04L 5/0053; H04W 72/0453; H04W 72/0457; H04W 76/20

(57) ABSTRACT

Methods and apparatuses for two-stage layer-1 (L1) control information. A method of operating a user equipment (UE) includes receiving first information related to an operation with two-stage downlink (DL) control, receiving second information related to a control region for a first stage of the two-stage DL control, and receiving a first channel using N>=1 resources of the multiple resources. The control region includes multiple resources. The first channel includes a first control information. The method further includes determining, based on the first control information, a resource allocation of a second channel and a size of a payload for the second channel and receiving the second channel. The second channel includes a second control information related to a second stage of the two-stage DL control.

### CROSS-REFERENCE TO RELATED AND CLAIM OF PRIORITY

The present application claims priority under 35 U.S.C. § 119(e) to U.S. Provisional Patent Application No. 63/547,261 filed on Nov. 3, 2023, and U.S. Provisional Patent Application No. 63/601,597 filed on Nov. 21, 2023, which are hereby incorporated by reference in their entirety.

### TECHNICAL FIELD

The present disclosure relates generally to wireless communication systems and, more specifically, the present disclosure relates to methods and apparatuses for two-stage layer-1 (L1) control information.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to two-stage L1 control information.

In one embodiment, a user equipment (UE) is provided. The UE includes a transceiver configured to receive first information related to an operation with two-stage downlink (DL) control, receive second information related to a control region for a first stage of the two-stage DL control, and receive a first channel using N>=1 resources of the multiple resources. The control region includes multiple resources. The first channel includes a first control information. The UE includes a processor operably coupled to the transceiver. The processor is configured to determine, based on the first control information, (i) a resource allocation of a second channel and (ii) a size of a payload for the second channel. The transceiver is further configured to receive the second channel. The second channel includes a second control information related to a second stage of the two-stage DL control.

In another embodiment, a base station (BS) is provided. The BS includes a transceiver configured to transmit first information related to an operation with two-stage DL control, transmit second information related to a control region for a first stage of the two-stage DL control, and transmit a first channel using N>=1 resources of the multiple resources. The control region includes multiple resources. The first channel includes a first control information. The BS further includes a processor operably coupled to the transceiver. The processor is configured to determine, based on the first control information, (i) a resource allocation of a second channel and (ii) a size of a payload for the second channel. The transceiver is further configured to transmit the second channel. The second channel includes a second control information related to a second stage of the two-stage DL control.

In yet another embodiment, a method of operating a UE is provided. The method includes receiving first information related to an operation with two-stage DL control, receiving second information related to a control region for a first stage of the two-stage DL control, and receiving a first channel using N>=1 resources of the multiple resources. The control region includes multiple resources. The first channel includes a first control information. The method further includes determining, based on the first control information, (i) a resource allocation of a second channel and (ii) a size of a payload for the second channel and receiving the second channel. The second channel includes a second control information related to a second stage of the two-stage DL control.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of example of a combination of higher level, MAC CE and DCI signaling according to embodiments of the present disclosure;

FIG. 8 illustrates a diagram of an example two-stage downlink control information (DCI) according to embodiments of the present disclosure;

FIG. 9 illustrates a diagram of an example two-stage DCI according to embodiments of the present disclosure;

FIG. 10 illustrates a diagram of an example two-stage DCI according to embodiments of the present disclosure;

FIGS. 11A, 11B, and 11C illustrate diagrams of example two-stage DCIs according to embodiments of the present disclosure;

FIGS. 12A, 12B, 12C, and 12D illustrate example timelines for two-stage DCI according to embodiments of the present disclosure;

FIGS. 13A, 13B, and 13C illustrate diagrams of an example two-stage DCI according to embodiments of the present disclosure;

FIGS. 14A, 14B, 14C, and 14D illustrate diagrams of an example two-stage DCI according to embodiments of the present disclosure;

FIGS. 15A, 15B, and 15C illustrate diagrams of an example two-stage DCI according to embodiments of the present disclosure;

FIGS. 16A, 16B, 16C, 16D, 16E, and 16F illustrate diagrams of an example two-stage DCI according to embodiments of the present disclosure;

FIG. 17 illustrates a diagram for example first stage/part control information resources according to embodiments of the present disclosure;

FIGS. 18A and 18B illustrate diagrams for example first stage/part control information resources according to embodiments of the present disclosure;

FIGS. 19A and 19B illustrate example time/frequency resource allocations for time/frequency resource allocations according to embodiments of the present disclosure;

FIGS. 20A, 20B, 20C, 20D, 20E, 20F, 20G, 20H, and 20I illustrate diagrams of example aggregation levels according to embodiments of the present disclosure;

FIG. 21 illustrates a diagram for example second stage/part control information resources according to embodiments of the present disclosure;

FIGS. 22A and 22B illustrate diagrams for example second stage/part control information resources according to embodiments of the present disclosure;

FIGS. 23A and 23B illustrate example time/frequency resource allocations for time/frequency resource allocations according to embodiments of the present disclosure;

FIGS. 24A, 24B, 24C, 24D, 24E, 24F, 24G, 24H, and 24I illustrate diagrams of an example two-stage DCI according to embodiments of the present disclosure;

FIGS. 25A, 25B, 25C, 25D, 25E, 25F, 25G, 25H, 25I, 25J, 25K, and 25L illustrate diagrams of an example two-stage DCI according to embodiments of the present disclosure;

FIGS. 26A, 26B, and 26C illustrate example timelines for mapping second stage control information according to embodiments of the present disclosure;

FIGS. 27A and 27B illustrate example timelines for updating transmission configuration indication (TCI) states according to embodiments of the present disclosure;

FIG. 28 illustrates a diagram of an example first and second stage/part control information according to embodiments of the present disclosure;

FIG. 29 illustrates a diagram of an example two-stage DCI according to embodiments of the present disclosure;

FIG. 30 illustrates a diagram of an example two-stage DCI according to embodiments of the present disclosure;

FIG. 31 illustrates a diagram of an example two-stage DCI according to embodiments of the present disclosure;

FIG. 32 illustrates a diagram of an example two-stage DCI according to embodiments of the present disclosure;

FIG. 33 illustrates a diagram of an example two-stage DCI according to embodiments of the present disclosure;

FIG. 34 illustrates a diagram of an example two-stage DCI according to embodiments of the present disclosure;

FIG. 35 illustrates a diagram of an example two-stage DCI according to embodiments of the present disclosure;

FIG. 36 illustrates a diagram of an example first stage/part control information according to embodiments of the present disclosure;

FIG. 37 illustrates a diagram of example first stage/part control information resources and feedback according to embodiments of the present disclosure;

FIG. 38 illustrates an example timeline for a two stage DCI according to embodiments of the present disclosure;

FIG. 39 illustrates an example timeline for a two stage DCI according to embodiments of the present disclosure;

FIG. 40 illustrates a diagram of an example two-stage DCI according to embodiments of the present disclosure;

FIG. 41 illustrates a flowchart of an example procedure for scheduling downlink (DL) data using a two-stage DCI according to embodiments of the present disclosure; and

FIG. 42 illustrates a flowchart of an example procedure for scheduling uplink (UL) data using a two-stage DCI according to embodiments of the present disclosure.

### DETAILED DESCRIPTION

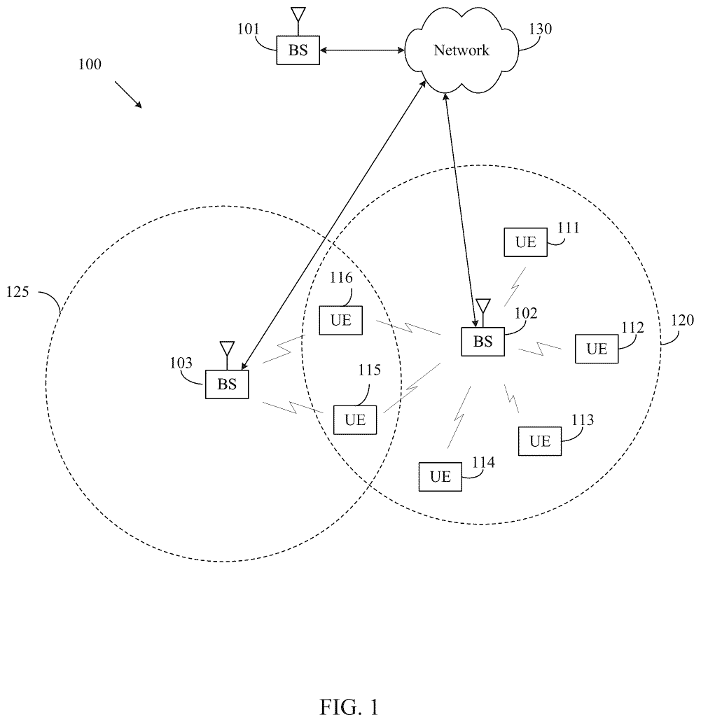

FIGS. 1-42, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v18.3.0, “NR; Physical channels and modulation;” [2] 3GPP TS 38.212 v18.3.0, “NR; Multiplexing and Channel coding;” [3] 3GPP TS 38.213 v18.3.0, “NR; Physical Layer Procedures for Control;” [4] 3GPP TS 38.214 v18.3.0, “NR; Physical Layer Procedures for Data;” [5] 3GPP TS 38.321 v18.2.0, “NR; Medium Access Control (MAC) protocol specification;” [6] 3GPP TS 38.331 v18.2.0, “NR; Radio Resource Control (RRC) Protocol Specification;” and [7] 3GPP RP-202024, “Revised WID: Further enhancements on MIMO for NR.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing two-stage L1 control information procedures. In certain embodiments, one or more of the BSs 101-103 include circuitry, programing, or a combination thereof to support or handle two-stage L1 control information.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

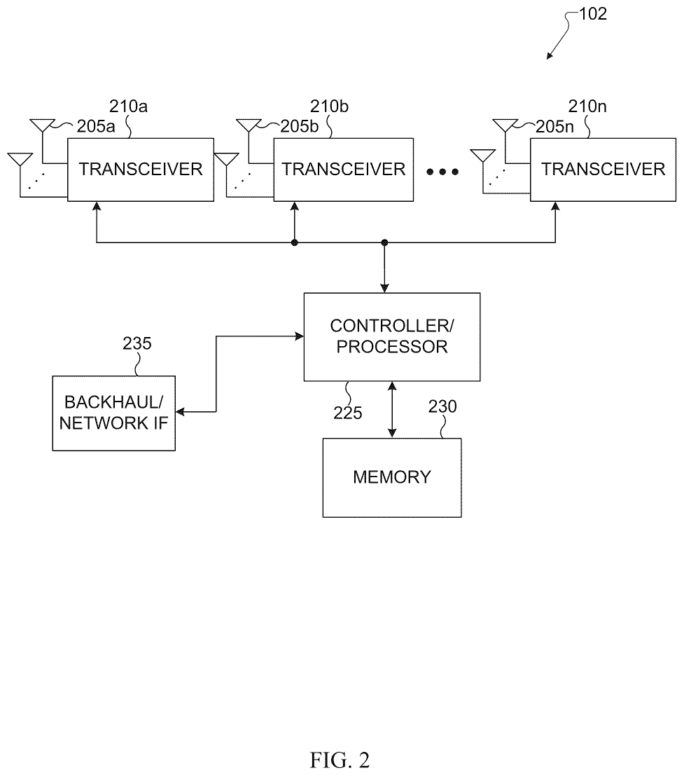

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting or handling two-stage L1 control information. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

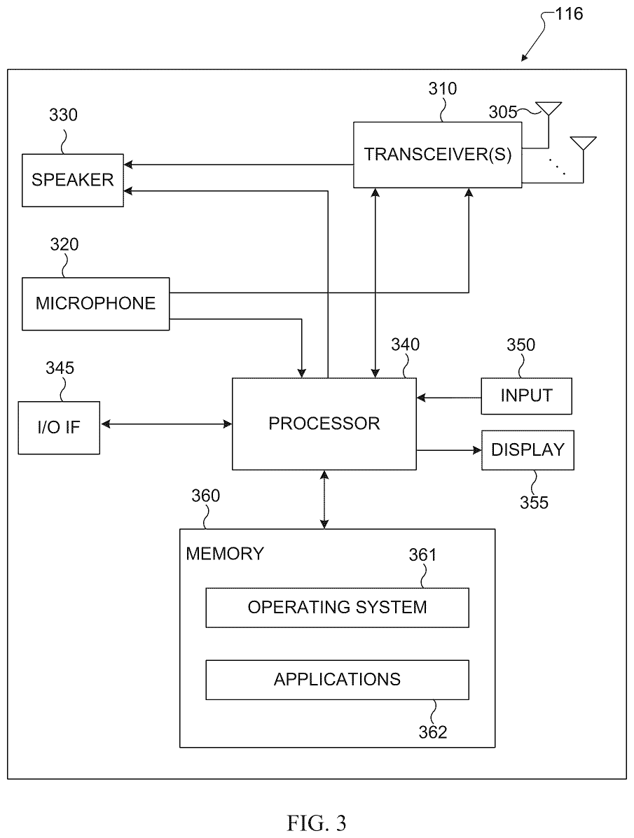

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform two-stage L1 control information processes as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

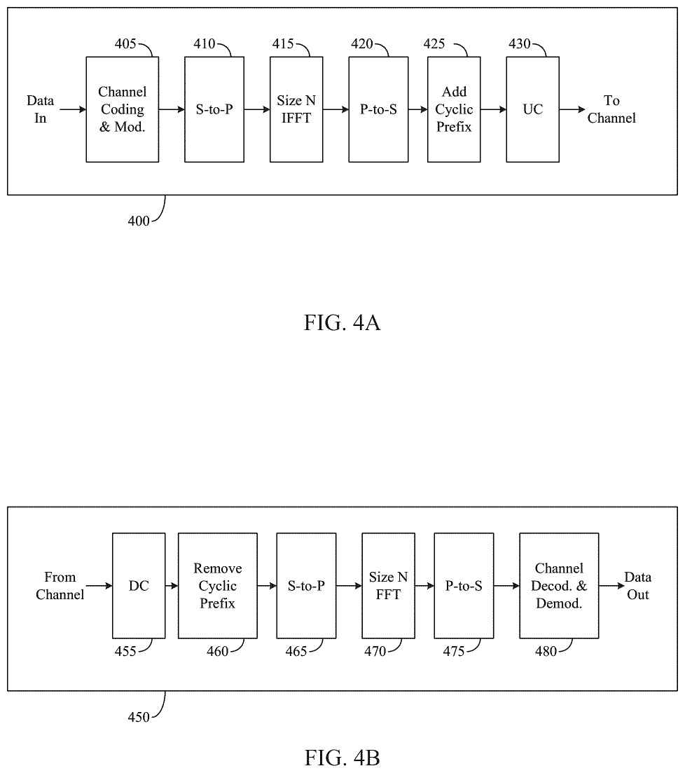

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support two-stage L1 control information as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

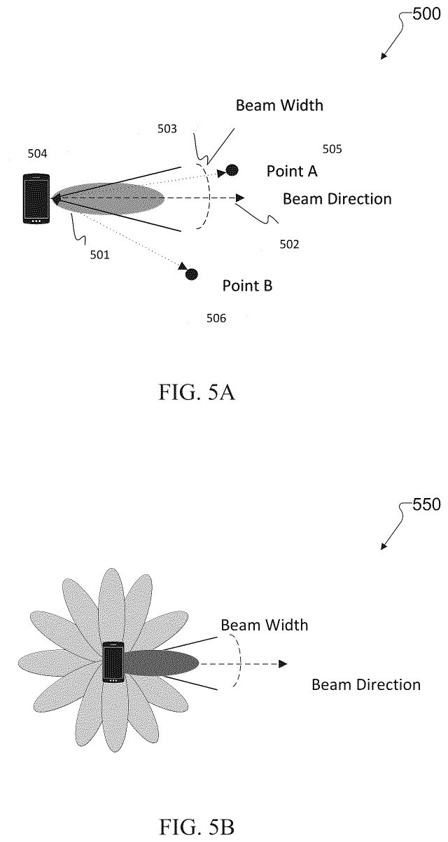

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

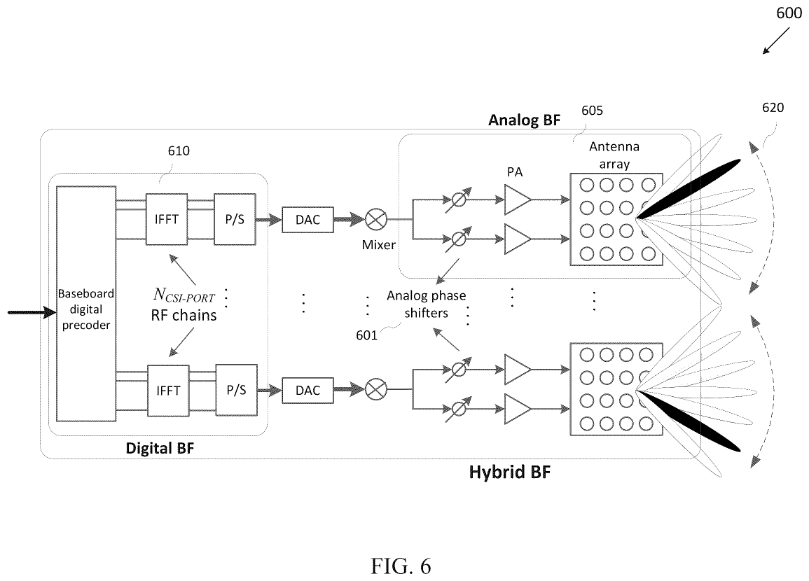

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication reference signal (CSI-RS) antenna ports which enable an eNB or a gNB to be equipped with a large number of antenna elements (such as 64 or 128). A plurality of antenna elements can then be mapped onto one CSI-RS port. For mm Wave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of subject matter is defined by the claims.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and/or sounding reference signal (SRS) and a target reference signal.
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE. The TCI state and/or the spatial relation reference RS can determine a spatial Tx filter for transmission of downlink channels from the gNB, or a spatial Rx filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on physical downlink shared channel (PDSCH)/physical downlink control channel (PDCCH) or dynamic-grant/configured-grant based physical uplink shared channel (PUSCH) and dedicated physical uplink control channel (PUCCH) resources.

The unified TCI framework applies to intra-cell beam management, wherein the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214 [REF4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and a source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and SRS.

A UE (e.g., the UE 116) is indicated a TCI state by MAC CE when the MAC CE activates one TCI state code point. The UE applies the TCI state code point after a beam application time from the corresponding hybrid automatic repeat request acknowledgement (HARQ-ACK) feedback. An UE is indicated a TCI state by a DL related downlink control information (DCI) format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback.

In this disclosure, two stage/part control information is provided. Where, the first stage/part control information can have a fixed and/or small payload size, with a low reception and decoding complexity on the UE side. In one example, based on the outcome of the first stage/part control information decoding, a UE can decide whether or not proceed with the second stage/part control information decoding. In this disclosure aspects related to the structure of the two stage/part control information are provided. The resource allocation for two stage/part control information. The content of the first stage/part control information, as well as the quasi-co-location/spatial relation for the first stage/part control information and the second stage/part control information.

In 5G/NR, downlink control information (DCI) is carried by physical downlink control channel (PDCCH). A DCI can include scheduling information for DL, UL or SL data, as well as other types of control information. The UE continuously monitors PDCCH candidates, to determine control information intended for it. This is done by blind decoding the PDCCH candidates, to limit UE's computation complexity, the number of PDCCH candidates that require blind decoding per-slot is limited to M_{PDCCH}^{max,μ}={44,36,22,20}, for sub-carrier spacing (SCS) configuration μ of {0,1,2,3} respectively. In 5G/NR, the DCI size budget limited by “3+1”, with a limited number of decode hypothesis. Despite this, the UE power consumption due to control channel processing is high. Over 98% of the UE's power consumption is consumed for control channel monitoring [Evolution if Power Saving Techniques for 5G New Radio, Kim et. al,]. To reduce the computation complexity of the UE's reception and decoding procedures, having a fixed size control information channel and/or a control information channel with a small payload will be beneficial. For example, by having a fixed size control channel information, the number of decoding hypothesis can be reduced (a single size is decoded blindly by the UE). By having a small payload for the control information, the decoding complexity of the UE is reduced. However, embodiments of the present disclosure recognize that as control information caters to different use cases, having fixed and small size control information is usually too restrictive. To address this, two stage/part control information can be a solution. The first stage/part control information is blind decoded by the UE, and provides necessary information on the resources and/or type and/or size of the second stage/part control information. The first stage/control information can include an indication to the UE, whether it needs to receive and decode the second stage/part control information, for example, this can be based on including or indicating in the first control stage/part control information a user identity or a radio network temporary identifier associated with the UE. In 5G/NR, the size of the DCI is limited, e.g., to 140 bits, with 2 stage/part downlink control the size of the DCI can increase, as the size of the second stage/part control information is indicated in the first stage control information. Furthermore, the second stage/part control information can use LPDC coding, which can allow the increase in payload size of control information beyond 140 bits without increasing the UE's complexity. In one example, DL MAC CEs can be conveyed using DCI (e.g., DL MAC CEs can be conveyed in second stage/part control information).

In this disclosure, the design of two stage/part control information is provided. A UE can perform blind decoding on the first stage/part control information which can have a fixed size and/or small payload size, with a low reception and decoding complexity on the UE side. Aspects related to the structure and design of channel or signal that conveys the first stage/part control information are provided as well as the channel or signal that conveys the second stage/part control information. Aspects related to resources configured and allocated to the first stage/part control information and second stage/part control information are provided. In one example, based on the outcome of the first stage/part control information decoding, a UE can decide whether or not proceed with the second stage/part control information decoding. The payload of the first stage/part control information can include information to assist the UE determine the presence of the second stage/part control information intended for that UE, as well as information to assist the UE in decoding this control information such as allocated resources and/or payload type and/or size and/or information to assist the UE in decoding the second stage/part control information and other information multiplexed in same shared channel (e.g., higher layer shared channel), and/or quasi-co-location/spatial relation/beam information. The relation between the quasi-co-location/spatial relation/beam information of the channel or signal conveying the first stage/part control information and that of the channel or signal conveying the second stage/part control information is also provided. For example, the first stage/part control information can be transmitted/received with a wider beam, and the indicate a narrower beam within the wide beam for the UE to receive the second stage/part control information and/or shared channel with higher layer data.

The present disclosure relates to a 5G/NR and/or 6G communication system.

This disclosure provides aspects related to design of two stage/part control information:
Two-stage control information, with first stage being a fixed-size low-decode complexity channel.
Channel structure and resource allocation for the first stage/part control information and the second state/part control information.
Payload for first stage/part control information to provide information to assist in decoding second stage, such as size, type, beam and/or port(s), resource allocation, etc.
Quasi-co-location/spatial relation/beam information of the channel or signal conveying the first stage/part control information and that of the channel or signal conveying the second stage/part control information.

In the following, both FDD and TDD are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling.

In this disclosure MAC CE signaling can be UE-specific e.g., to one UE and/or can be UE common (e.g., to a group of UEs). MAC CE signaling can be DL MAC CE signaling or UL MAC CE signaling.

In this disclosure L1 control signaling includes: (1) DL control information (e.g., DCI on PDCCH) and/or (2) UL control information (e.g., uplink control information (UCI) on PUCCH or PUSCH). L1 control signaling can be UE-specific e.g., to one UE and/or can be UE common (e.g., to a group of UEs).

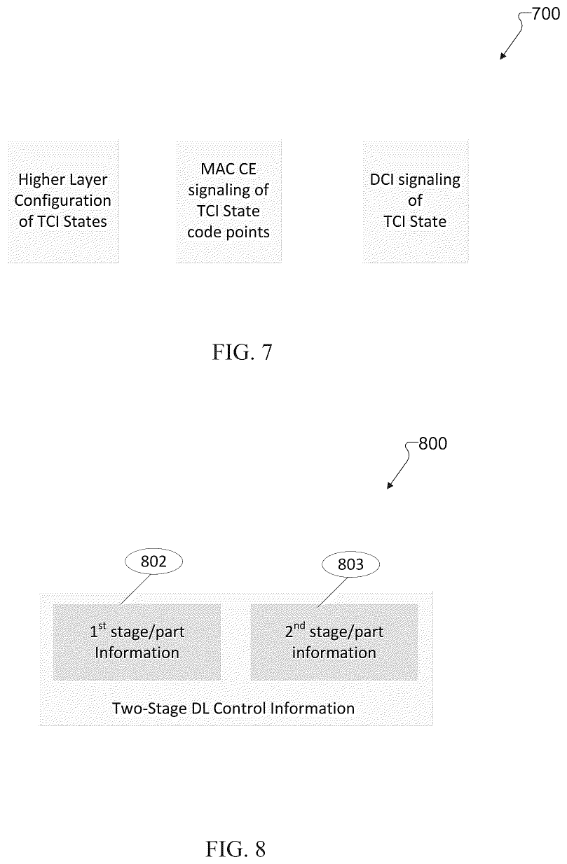

FIG. 7 illustrates a diagram of example of a combination of higher level, MAC CE and DCI signaling 700 according to embodiments of the present disclosure. For example, higher level, MAC CE and DCI signaling 700 can be received by the UE 111 of FIG. 1. This example is for illustration only and other embodiments can be used without departing from the scope of the present disclosure.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as nonzero power (NZP) CSI-RS and/or SSB) with the result of the measurement used for calculating a beam report (e.g., including at least one layer 1 reference signal received power (L1-RSRP)/L1-signal-to-interference-plus-noise ratio (SINR) accompanied by at least one channel state information reference signal (CSI-RS) resource indicator (CRI) or synchronization signal block resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the information to assign a particular DL (or/and UL) TX beam to the UE.

In the following components, a TCI state is used for beam indication. It can refer to a DL TCI state for downlink channels or signals (e.g. PDCCH and PDSCH and CSI-RS), an uplink TCI state for uplink channels or signals (e.g. PUSCH or PUCCH or SRS), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

With reference to FIG. 7 in the following examples, a UE is configured/updated through higher layer RRC signaling a set of TCI States with L elements. In one example, DL and joint TCI states are configured by higher layer parameter DLorJoint-TCIState, wherein, the number of DL and Joint TCI state is L_{DJ}. UL TCI state are configured by higher layer parameter UL-TCIState, wherein the number of UL TCI state is L_{U}. L=L_{DJ}+L_{U}, wherein L is the total number of DL, Joint and UL TCI states. In one example, DL, UL and Joint TCI states are configured by a higher layer parameter, wherein the number of DL, UL and Joint TCI state is L.

MAC CE signaling includes a subset of K (K≤L) TCI states or TCI state code points from the set of L TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e. Downlink Control Information (DCI)) updates the UE's TCI state, wherein the DCI includes a “transmission configuration indication” (beam indication) field e.g. with k bits (such that K≤2^{k}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein, the source RS (e.g., for a QCL Type D relation or a spatial relation) can be a reference signal, and the reference signal has the SSB as its source (e.g., for a QCL Type D relation or a spatial relation). The indirect QCL relation to an SSB can involve a QCL or spatial relation chain of more than one reference signal.

The UE can use a DL related DCI (e.g., DCI Format 1_1 or DCI Format 1_2) without DL assignment, for beam indication. For example, the use of DL related DCI without DL assignment, can be configured by higher layers, or can be specified in the system specification.

Alternatively, the UE can use a DL related DCI (e.g., DCI Format 1_1 or DCI Format 1_2) with DL assignment, for beam indication. For example, the use of DL related DCI with DL assignment, can be configured by higher layers, or can be specified in the system specification.

Alternatively, the UE can use an UL related DCI (e.g., DCI Format 0_1 or DCI Format 0_2) with UL grant, for beam indication. For example, the use of UL related DCI with UL grant, can be configured by higher layers, or can be specified in the system specification.

Alternatively, the UE can use an UL related DCI (e.g., DCI Format 0_1 or DCI Format 0_2) without UL grant, for beam indication. For example, the use of UL related DCI without UL grant, can be configured by higher layers, or can be specified in the system specification.

Alternatively, the UE can use a DCI, for beam indication. For example, the use DCI for beam indication, can be configured by higher layers, or can be specified in the system specification.

Alternatively, the UE can use a purpose designed channel or signal, for beam indication. For example, the use the purpose designed channel or signal for beam indication, can be configured by higher layers, or can be specified in the system specification.

In the following examples, the “transmission configuration indication” provided by a DCI format or a purpose designed channel or signal for beam indication includes a TCI state codepoint activated by MAC CE or configured by RRC. Wherein, the TCI state codepoint can be one of:
Joint TCI state used for UL transmissions and DL receptions by the UE.
DL TCI state used for DL receptions by the UE.
UL TCI state used for UL transmissions by the UE.
DL TCI state used for DL receptions by the UE and UL TCI states used for UL transmissions by the UE.

In the following examples, the “transmission configuration indication” provided by a DCI format or a purpose designed channel or signal for beam indication includes a TCI state codepoint activated by MAC CE or configured by RRC. Wherein, the TCI state codepoint can include TCI state(s) for one entity or can include TCI state(s) for multiple entities. Wherein, an entity can be one or more of the following:
A transmission reception point (TRP)
A coreset pool index
A network panel (e.g., TRP panel)
A UE panel
A cell (e.g., a cell associated with a PCI)
A component carrier
A bandwidth part (BWP)

FIG. 8 illustrates a diagram of an example two-stage DCI 800 according to embodiments of the present disclosure. For example, two-stage DCI 800 can be received by any of the UEs 111-116 of FIG. 1, such as the UE 112. This example is for illustration only and other embodiments can be used without departing from the scope of the present disclosure.

With reference to FIG. 8, DL control information can comprise of two stages/parts. A first stage/part DL control information (802) and a second stage/part DL control information (803). Downlink control information (DCI) can be signaled using a channel/signal, wherein one channel or signal is used for a first information, and a second channel or signal is used for a second information. In one example, both the first stage/part control information and the second stage/part control information are present. In one example, the first stage/part control information may be absent. In one example, the second stage/part control information may be absent.

In one example, the network (e.g., the network 130) can configure a UE to operate using a two stages/parts for DL control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the network can configure a UE to operate using a one stage/part for DL control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the default mode of operation if the UE doesn't receive any additional signaling is one stage/part control information. The UE maybe further configured as mentioned herein to operate using two stage/part control information.

In one example, the default mode of operation if the UE doesn't receive any additional signaling is two stage/part control information. The UE maybe further configured as mentioned herein to operate using one stage/part control information.

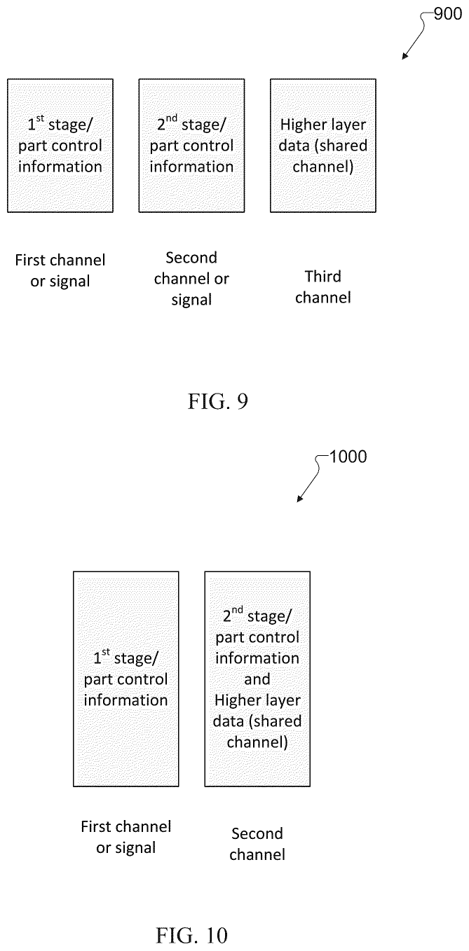

FIG. 9 illustrates a diagram of an example two-stage DCI 900 according to embodiments of the present disclosure. For example, two-stage DCI 900 can be received by any of the UEs 111-116 of FIG. 1, such as the UE 113. This example is for illustration only and other embodiments can be used without departing from the scope of the present disclosure.

In one example, the first stage/part DL control information is transmitted in a first channel or signal (e.g., physical downlink control channel (PDCCH)). In one example, the first stage/part DL control information is a low power wake up signal (LP-WUS). In one example, the second stage/part DL control information is transmitted in a second channel or signal (e.g., PDCCH or physical downlink shared channel (PDSCH)). In one example, higher layer data (e.g., higher layer shared channel, e.g., DL-SCH or UL-SCH) is transmitted in a third channel, e.g., PDSCH, illustrated in FIG. 9. In one example, the first stage/part DL control information is transmitted in the first stage/part control information region as described later in this disclosure, the second stage/part DL control information is transmitted in the second stage/part control information region as described later in this disclosure, and the shared channel is transmitted in resources indicated or determined by the first and/or second stage/part DL control information (e.g., outside the first stage/part control information region and the second stage/part control information region). In one example, the first stage/part DL control information is transmitted in the first stage/part control information region, the second stage/part control information is transmitted in resources indicated or determined by the first stage/part DL control information (e.g., outside the first stage/part control information region), and the shared channel is transmitted in resources indicated or determined by the first and/or second stage/part DL control information (e.g., outside the first stage/part control information region). In one example, Polar coding is used for first stage/part control information. In one example, Polar coding is used for second stage/part control information. In one example, LDPC coding is used for second stage/part control information.

FIG. 10 illustrates a diagram of an example two-stage DCI 1000 according to embodiments of the present disclosure. For example, two-stage DCI 1000 can be received by any of the UEs 111-116 of FIG. 1, such as the UE 114. This example is for illustration only and other embodiments can be used without departing from the scope of the present disclosure.

In one example, the first stage/part DL control information is transmitted in a first channel or signal (e.g., PDCCH). In one example, the first stage/part DL control information is a low power wake up signal (LP-WUS). In one example, the second stage/part DL control information and higher layer data (e.g., higher layer shared channel, e.g., DL-SCH) are transmitted in a second channel (e.g., PDSCH) illustrated in FIG. 10. In one example, the first stage/part DL control information is transmitted in the first stage/part control information region as described later in this disclosure, the second stage/part DL control information and shared channel are transmitted in the second stage/part control information region. In one example, the first stage/part DL control information is transmitted in the first stage/part control information region as described later in this disclosure, the second stage/part control information and shared channel are transmitted in resources indicated or determined by the first stage/part DL control information (e.g., outside the first stage/part control information region). In one example, Polar coding is used for first stage/part control information. In one example, Polar coding is used for second stage/part control information. In one example, LDPC coding is used for second stage/part control information.

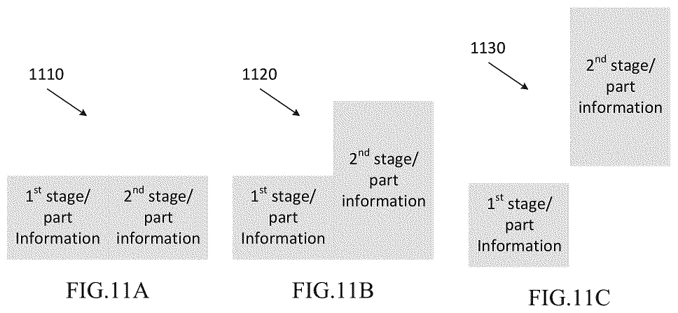

FIGS. 11A, 11B, and 11C illustrate diagrams of example two-stage DCIs 1110, 1120, and 1130, respectively, according to embodiments of the present disclosure. For example, two-stage DCIs 1110, 1120, and 1130, respectively, can be received by any of the UEs 111-116 of FIG. 1, such as the UE 115. This example is for illustration only and other embodiments can be used without departing from the scope of the present disclosure.

With reference to FIG. 11, in one example, the first stage/part and the second stage part are time division multiplexed as shown.

In one example, the first stage/part control information and the second stage/part control information have the same frequency span, as illustrated in FIG. 11A.

In one example, the first stage/part control information and the second stage/part control information can have different frequency spans, as illustrated in FIG. 11B and FIG. 11C.

In one example, the frequency span of the first stage/part control information and the frequency span of the second stage/part control information overlap (e.g., fully or partially) as illustrated in FIG. 11B.

In one example, the frequency span of the first stage/part control information and the frequency span of the second stage/part control information don't overlap as illustrated in FIG. 11C.

In one example, the start frequency of the first stage/part control information and the start frequency of the second stage/part control information are the same as illustrated in FIG. 11B.

In one example, the start frequency of the first stage/part control information and the end frequency of the second stage/part control information are the same.

In one example, the end frequency of the first stage/part control information and the start frequency of the second stage/part control information are the same.

In one example, the end frequency of the first stage/part control information and the end frequency of the second stage/part control information are the same.

In one example, the start frequency of the first stage/part control information is larger than the start frequency of the second stage/part control information.

In one example, the start frequency of the first stage/part control information is smaller than the start frequency of the second stage/part control information.

In one example, the start frequency of the first stage/part control information is larger than the end frequency of the second stage/part control information.

In one example, the start frequency of the first stage/part control information is smaller than the end frequency of the second stage/part control information.

In one example, the end frequency of the first stage/part control information is larger than the start frequency of the second stage/part control information.

In one example, the end frequency of the first stage/part control information is smaller than the start frequency of the second stage/part control information.

In one example, the end frequency of the first stage/part control information is larger than the end frequency of the second stage/part control information.

In one example, the end frequency of the first stage/part control information is smaller than the end frequency of the second stage/part control information.

In one example, the time duration of the first stage/part control information and the time duration of the second stage/part control information are the same.

In one example, the time duration of the first stage/part control information and the time duration of the second stage/part control information can be different.

In one example, the first stage/part control information and the second stage/part control information are in a same time unit, wherein a time unit can be a symbol or N-symbols, or a slot, or N-slots, or a sub-frame, or N sub-frames or a frame or N-frames, N can be specified in the system specifications and/or configured or updated by RRC signaling and/or MAC CE signaling and/or L1 control (e.g., DCI Format) signaling.

In one example, the first stage/part control information and the second stage/part control information can be in different time units, wherein a time unit can be a symbol or N-symbols, or a slot, or N-slots, or a sub-frame, or N sub-frames or a frame or N-frames, N can be specified in the system specifications and/or configured or updated by RRC signaling and/or MAC CE signaling and/or L1 control (e.g., DCI Format) signaling.

With reference to FIG. 11, in one example, there is no time gap between first stage/part control information and the second stage/part control information.

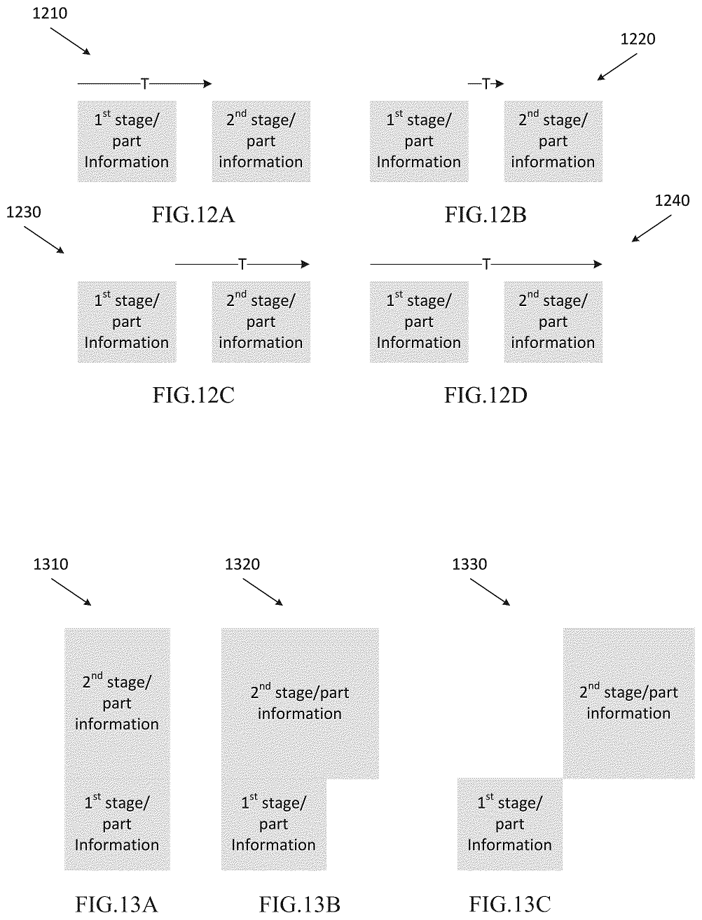

FIGS. 12A, 12B, 12C, and 12D illustrate example timelines 1210, 1220, 1230, and 1240, respectively, for two-stage DCI according to embodiments of the present disclosure. For example, timelines 1210, 1220, 1230, and 1240, respectively, for two-stage DCI can be followed by any of the UEs 111-116 of FIG. 1, such as the UE 116 of FIG. 3. This example is for illustration only and other embodiments can be used without departing from the scope of the present disclosure.

In one example, there is a time gap between the first stage/part control information and the second stage/part control information, wherein one or more of the following can be configured or indicated or updated to the UE:
Time, T, between the start of the first stage/part of control information channel or signal and the start of the second stage/part of control information channel or signal as illustrated in FIG. 12A.
Time, T, between the end of the first stage/part of control information channel or signal and the start of the second stage/part of control information channel or signal as illustrated in FIG. 12B.
Time, T, between the end of the first stage/part of control information channel or signal and the end of the second stage/part of control information channel or signal as illustrated in FIG. 12C.
Time, T, between the start of the first stage/part of control information channel or signal and the end of the second stage/part of control information channel or signal as illustrated in FIG. 12D.
Time, T, between the start of the first stage/part of control information region (as described later in this disclosure) and the start of the second stage/part of control information channel or signal.
Time, T, between the end of the first stage/part of control information region (as described later in this disclosure) and the start of the second stage/part of control information channel or signal.
Time, T, between the end of the first stage/part of control information region (as described later in this disclosure) and the end of the second stage/part of control information channel or signal.
Time, T, between the start of the first stage/part of control information region (as described later in this disclosure) and the end of the second stage/part of control information channel or signal.

In one example, T can be specified in the system specifications and/or configured or updated by higher signaling (e.g., UE (e.g., the UE 116) dedicated signaling and/or cell-specific SIB signaling) and/or MAC CE signaling and/or L1 control (e.g., DCI Format) signaling.

In one example, T can be indicated or determined by the first stage/part control information.

In one example, T can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) time of the 2^{nd} stage/part control information can be indicated or determined by the first stage/part control information.

In one example, starting (or ending) time of the 2^{nd} stage/part control information can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, the resource used for the second stage/part control information can be indicated or determined by the first stage/part control information.

In one example, the resource used for the second stage/part control information is determined based at least on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

FIGS. 13A, 13B, and 13C illustrate diagrams of an example two-stage DCI 1310, 1320, and 1330, respectively, according to embodiments of the present disclosure. For example, two-stage DCI 1310, 1320, and 1330, respectively, can be received by any of the UEs 111-116 of FIG. 1, such as the UE 111. This example is for illustration only and other embodiments can be used without departing from the scope of the present disclosure.

With reference to FIG. 13, in one example, the first stage/part and the second stage part are frequency division multiplexed as shown.

In one example, the first stage/part control information and the second stage/part control information have the same time duration, as illustrated in FIG. 13A.

In one example, the first stage/part control information and the second stage/part control information can have different time durations, as illustrated in FIG. 13B and FIG. 13C.

In one example, the time duration of the first stage/part control information and the time duration of the second stage/part control information overlap (e.g., partially or fully) as illustrated in FIG. 13B.

In one example, the time duration of the first stage/part control information and the time duration of the second stage/part control information don't overlap as illustrated in FIG. 13C.

In one example, the start time of the first stage/part control information and the start time of the second stage/part control information are the same as illustrated in FIG. 13B.

In one example, the start time of the first stage/part control information and the end time of the second stage/part control information are the same.

In one example, the end time of the first stage/part control information and the start time of the second stage/part control information are the same.

In one example, the end time of the first stage/part control information and the end time of the second stage/part control information are the same.

In one example, the start time of the first stage/part control information is larger than the start time of the second stage/part control information.

In one example, the start time of the first stage/part control information is smaller than the start time of the second stage/part control information.

In one example, the start time of the first stage/part control information is larger than the end time of the second stage/part control information.

In one example, the start time of the first stage/part control information is smaller than the end time of the second stage/part control information.

In one example, the end time of the first stage/part control information is larger than the start time of the second stage/part control information.

In one example, the end time of the first stage/part control information is smaller than the start time of the second stage/part control information.

In one example, the end time of the first stage/part control information is larger than the end time of the second stage/part control information.

In one example, the end time of the first stage/part control information is smaller than the end time of the second stage/part control information.

In one example, the frequency span of the first stage/part control information and the frequency span of the second stage/part control information are the same.

In one example, the frequency span of the first stage/part control information and the frequency span of the second stage/part control information can be different.

With reference to FIG. 13, in one example, there is no frequency gap between first stage/part control information and the second stage/part control information.

In one example, the first stage/part control information and the second stage/part control information are in a same bandwidth part (BWP).

In one example, the first stage/part control information and the second stage/part control information can be in different BWPs.

In one example, the first stage/part control information and the second stage/part control information are in a same component carrier.

In one example, the first stage/part control information and the second stage/part control information can be in different component carriers.

In one example, the first stage/part control information and the second stage/part control information are in a same frequency band.

In one example, the first stage/part control information and the second stage/part control information can be in different frequency bands.

In one example, the first stage/part control information and the second stage/part control information are in a same frequency region (e.g., FR1 or FR2 or FR3 or FR2-1 or FR2-2).

In one example, the first stage/part control information and the second stage/part control information can be in different frequency regions (e.g., FR1 or FR2 or FR3 or FR2-1 or FR2-2).

FIGS. 14A, 14B, 14C, and 14D illustrate diagrams of an example two-stage DCI 1410, 1420, 1430, and 1440, respectively, according to embodiments of the present disclosure. For example, two-stage DCI 1410, 1420, 1430, and 1440, respectively, can be received by any of the UEs 111-116 of FIG. 1, such as the UE 114. This example is for illustration only and other embodiments can be used without departing from the scope of the present disclosure.

In one example, there is a frequency gap between the first stage/part control information and the second stage/part control information, wherein one or more of the following can be configured or indicated or updated to the UE:
Frequency, F, between the start of the first stage/part of control information channel or signal and the start of the second stage/part of control information channel or signal as illustrated in FIG. 14A.
Frequency, F, between the end of the first stage/part of control information channel or signal and the start of the second stage/part of control information channel or signal as illustrated in FIG. 14B.
Frequency, F, between the end of the first stage/part of control information channel or signal and the end of the second stage/part of control information channel or signal as illustrated in FIG. 14C.
Frequency, F, between the start of the first stage/part of control information channel or signal and the end of the second stage/part of control information channel or signal as illustrated in FIG. 14D.
Frequency, F, between the start of the first stage/part of control information region (as described later in this disclosure) and the start of the second stage/part of control information channel or signal.
Frequency, F, between the end of the first stage/part of control information region (as described later in this disclosure) and the start of the second stage/part of control information channel or signal.
Frequency, F, between the end of the first stage/part of control information region (as described later in this disclosure) and the end of the second stage/part of control information channel or signal.
Frequency, F, between the start of the first stage/part of control information region (as described later in this disclosure) and the end of the second stage/part of control information channel or signal.

In one example, F can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, F can be indicated or determined by the first stage/part control information.

In one example, F can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) frequency of the 2^{nd} stage/part control information can be indicated or determined by the first stage/part control information.

In one example, starting (or ending) frequency of the 2^{nd} stage/part control information can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, the resource used for the second stage/part control information can be indicated or determined by the first stage/part control information.

In one example, the resource used for the second stage/part control information is determined based at least on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

With reference to FIGS. 13 and 14, while the first stage/part of control information channel or signal is shown to have a lower frequency than the second stage/part of control information channel or signal, the order can be reversed such that the first stage/part of control information channel or signal has a higher frequency than the second stage/part of control information channel or signal.

FIGS. 15A, 15B, and 15C illustrate diagrams of an example two-stage DCI 1510, 1520, and 1530, respectively, according to embodiments of the present disclosure. For example, two-stage DCI 1510, 1520, and 1530, respectively, can be received by any of the UEs 111-116 of FIG. 1, such as the UE 113. This example is for illustration only and other embodiments can be used without departing from the scope of the present disclosure.

With reference to FIG. 15, in one example, the first stage/part and the second stage part are time and frequency division multiplexed as shown.

In one example, as illustrated in the example of FIG. 15A, the time and frequency resources of the first stage/part control information and the second stage/part control information don't overlap.

In one example, as illustrated in the example of FIG. 15B and FIG. 15C, the time and frequency resources of the first stage/part control information and the second stage/part information can overlap (e.g., fully or partially).

In one example, as illustrated in the example of FIG. 15B and FIG. 15C, there is no frequency gap and/or time gap between first stage/part control information and the second stage/part control information.

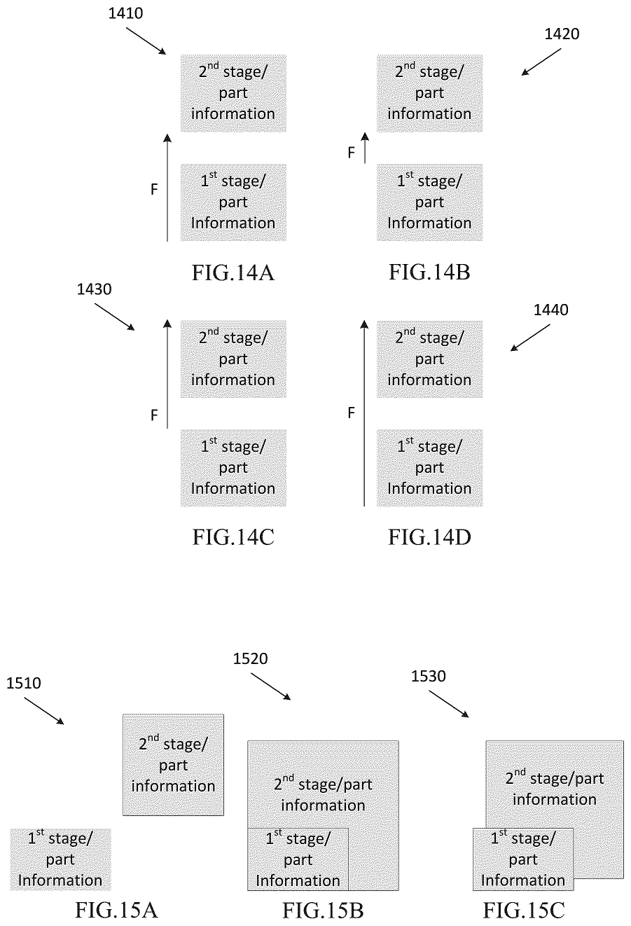

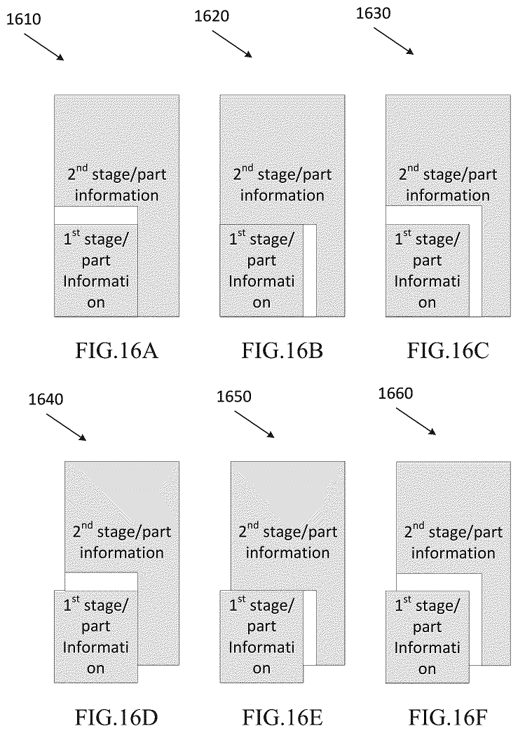

FIGS. 16A, 16B, 16C, 16D, 16E, and 16F illustrate diagrams of an example two-stage DCI 1610, 1620, 1630, 1640, 1650, and 1660, respectively, according to embodiments of the present disclosure. For example, two-stage DCI 1610, 1620, 1630, 1640, 1650, and 1660, respectively, can be received by any of the UEs 111-116 of FIG. 1, such as the UE 114. This example is for illustration only and other embodiments can be used without departing from the scope of the present disclosure.

In one example, there is a frequency gap and/or time gap between the first stage/part control information and the second stage/part control information as illustrated in FIG. 15A and the examples of FIG. 16, wherein one or more of the following can be configured or indicated or updated to the UE:
Frequency, F, between the start of the first stage/part of control information channel or signal and the start of the second stage/part of control information channel or signal.
Frequency, F, between the end of the first stage/part of control information channel or signal and the start of the second stage/part of control information channel or signal.
Frequency, F, between the end of the first stage/part of control information channel or signal and the end of the second stage/part of control information channel or signal.
Frequency, F, between the start of the first stage/part of control information channel or signal and the end of the second stage/part of control information channel or signal.
Frequency, F, between the start of the first stage/part of control information region (as described later in this disclosure) and the start of the second stage/part of control information channel or signal.
Frequency, F, between the end of the first stage/part of control information region (as described later in this disclosure) and the start of the second stage/part of control information channel or signal.
Frequency, F, between the end of the first stage/part of control information region (as described later in this disclosure) and the end of the second stage/part of control information channel or signal.
Frequency, F, between the start of the first stage/part of control information region (as described later in this disclosure) and the end of the second stage/part of control information channel or signal.
Time, T, between the start of the first stage/part of control information channel or signal and the start of the second stage/part of control information channel or signal.
Time, T, between the end of the first stage/part of control information channel or signal and the start of the second stage/part of control information channel or signal.
Time, T, between the end of the first stage/part of control information channel or signal and the end of the second stage/part of control information channel or signal.
Time, T, between the start of the first stage/part of control information channel or signal and the end of the second stage/part of control information channel or signal.
Time, T, between the start of the first stage/part of control information region (as described later in this disclosure) and the start of the second stage/part of control information channel or signal.
Time, T, between the end of the first stage/part of control information region (as described later in this disclosure) and the start of the second stage/part of control information channel or signal.
Time, T, between the end of the first stage/part of control information region (as described later in this disclosure) and the end of the second stage/part of control information channel or signal.
Time, T, between the start of the first stage/part of control information region (as described later in this disclosure) and the end of the second stage/part of control information channel or signal.

In one example, F and/or T can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, F and/or T can be indicated or determined by the first stage/part control information.

In one example, F and/or T can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) frequency of the 2^{nd} stage/part control information can be indicated or determined by the first stage/part control information.

In one example, starting (or ending) time of the 2^{nd} stage/part control information can be indicated or determined by the first stage/part control information.

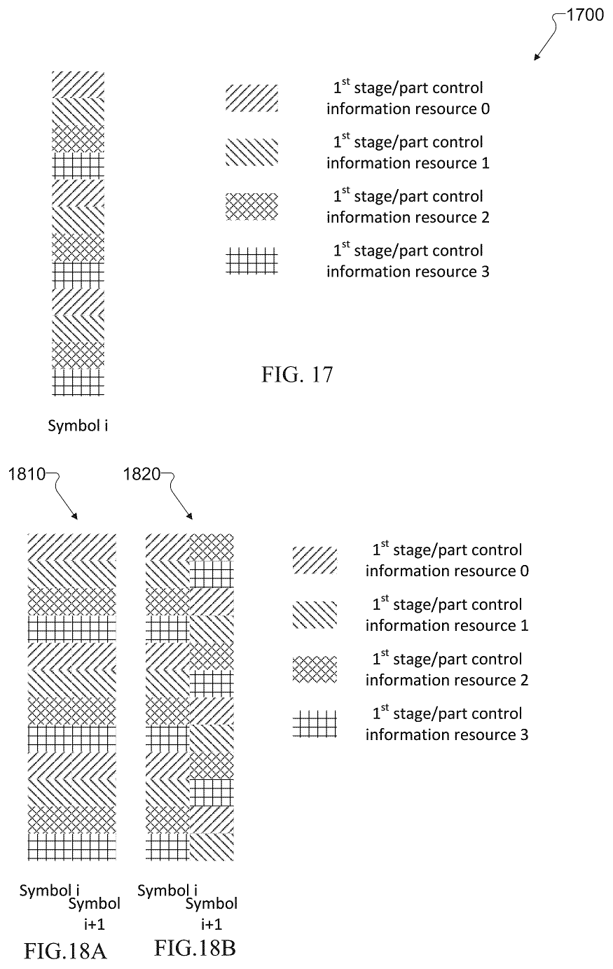

FIG. 17 illustrates a diagram for example first stage/part control information resources 1700 according to embodiments of the present disclosure (first stage/part control information region). For example, first stage/part control information resources 1700 can be utilized by the UE 116 of FIG. 3. This example is for illustration only and other embodiments can be used without departing from the scope of the present disclosure.

FIGS. 18A and 18B illustrate diagrams for example first stage/part control information resources 1810 and 1820, respectively, according to embodiments of the present disclosure. For example, first stage/part control information resources 1810 and 1820, respectively, can be utilized by the UE 111 of FIG. 1. This example is for illustration only and other embodiments can be used without departing from the scope of the present disclosure.

In one example, starting (or ending) frequency of the 2^{nd} stage/part control information can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) time of the 2^{nd} stage/part control information can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, the resource used for the second stage/part control information can be indicated or determined by the first stage/part control information.

In one example, the resource used for the second stage/part control information is determined based at least on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, the first stage/part control information can be transmitted in a first stage/part control information region, wherein the first stage/part control information region can include multiple resources, wherein a resource can be determined by one more of the following:
Frequency domain resources, for example one or more physical resource blocks (PRBs) or one or more sub-carriers, or subchannels or different comb offsets. In one example, the first stage/part control information is transmitted in a resource that has a comb-N, where every Nth sub-carrier or every Nth PRB or every Nth RB group (RBG or sub-channel) is used for the first stage/part control information resource. Different first stage/part control information resources can have different comb offsets as illustrated in FIG. 17. FIG. 17 is an example, of first stage/part control information resources with a comb-N structure, N=4 (for example), N (e.g., 4) different first stage/part control information resources are illustrated. In FIG. 17, a single symbol is used for the first stage/part control information resource. FIG. 18 is an example, of first stage/part control information resources with a comb-N structure, N=4 (for example), N (e.g., 4) different first stage/part control information resources are illustrated. In FIG. 18, two symbols are used for the first stage/part control information resource. In FIG. 18A for a same first stage/part control information resource a same comb offset is used in the two symbols. In FIG. 18B for a same first stage/part control information resource a different comb offset is used in the two symbols, the comb offsets are staggered. The examples, of FIG. 18 can be extended to more symbols.
Time domain resources, for example, one or more symbols or one or more slots
Code domain resources, for example a scrambling code. In one example, the scrambling code can depend at least on UE identity or group UE identity or radio network temporary identifier (RNTI), for example, the scrambling code is initialized at least based on UE identity or group UE identity or RNTI.

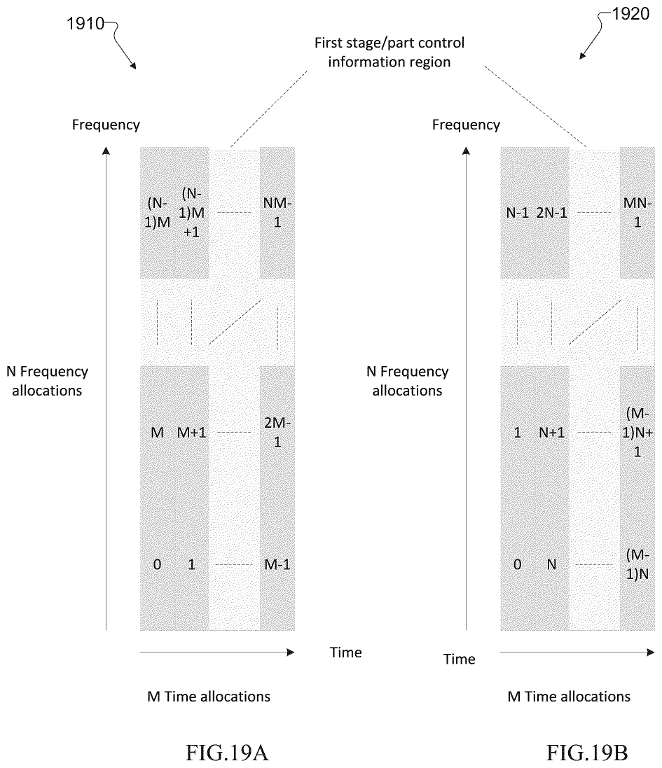

FIGS. 19A and 19B illustrate example time/frequency resource allocations 1910 and 1920, respectively, for time/frequency resource allocations according to embodiments of the present disclosure. For example, timelines 1910 and 1920, respectively, for time/frequency resource allocations can be followed by any of the UEs 111-116 of FIG. 1, such as the UE 116 of FIG. 3. This example is for illustration only and other embodiments can be used without departing from the scope of the present disclosure.

With reference to FIG. 19, an example of a first stage/part control information region, that includes M time allocations for time domain resources for first stage/part control information resources and N frequency allocations for frequency domain resources for first stage/part control information resources is shown. A time-frequency resource can be T time units, and F frequency units. In one example, a time unit is a symbol. In one example, a time unit is a slot. In one example, a time unit is a subframe. In one example, a time unit is a frame. In one example, frequency unit is a sub-carrier. In one example, a frequency unit is a physical resource block (PRB) (e.g., 12 sub-carriers). In one example, a frequency unit is a sub-channel. T and F can be specified in the system specifications and/or configured or updated by higher signaling (e.g., UE (e.g., the UE 116) dedicated signaling and/or cell-specific SIB signaling) and/or MAC CE signaling and/or L1 control (e.g., DCI Format) signaling. There can be M·N first stage/part control information resources. In one example, a first stage/part control information resource can be allocated to one of the M·N resources of FIG. 19. In one example, the resources are first indexed in ascending order of time resource and then ascending order of frequency resource as illustrated in FIG. 19A. In one example, the resources are first indexed in ascending order of frequency resource and then ascending order of time resource as illustrated in FIG. 19B.

In one example, the resources are first indexed in descending order of time resource and then descending order of frequency resource. In one example, the resources are first indexed in descending order of frequency resource and then descending order of time resource.

In one example, the resources are first indexed in ascending order of time resource and then descending order of frequency resource. In one example, the resources are first indexed in descending order of frequency resource and then ascending order of time resource.

In one example, the resources are first indexed in descending order of time resource and then ascending order of frequency resource. In one example, the resources are first indexed in ascending order of frequency resource and then descending order of time resource.

In a variant example, of FIG. 19, each time-frequency resource of FIG. 19, includes K resources that can be used for first stage/part control information resources. In one example, the K resources can correspond to different comb offsets. In one example, the K resources can correspond to different code-domain resources (for example different scrambling sequences). In one example, the K resources can correspond to combination of different comb offsets and/or different code-domain resources (for example different scrambling sequences). The indexing of the first stage/part control information resources can be in ascending or descending order of a time domain or frequency domain or code/comb domain resources and in the following order according to one of the following:
First code/comb domain, then time domain, then frequency domain.
First code/comb domain, then frequency domain, then time domain.
First time domain, then code/comb domain, then frequency domain.
First time domain, the frequency domain, then code/comb domain.
First frequency domain, then code/comb domain, then time domain.
First frequency domain, the time domain, then code/comb domain

In one example, as mentioned herein, a first stage/part control information channel or signal can be allocated to one resource in the first stage/part control information region.

In one example, a first stage/part control information channel or signal can be allocated to L resources in the first stage/part control information region. For example, an aggregation level of L. In one example, a first stage/part control information channel or signal can be allocated L_{T} time domain resources in the first stage/part control information region. In one example, a first stage/part control information channel or signal can be allocated L_{F} frequency domain resources in the first stage/part control information region. In one example, a first stage/part control information channel or signal can be allocated L_{C} code and/or comb domain resources in the first stage/part control information region. In one example, L=L_{T}L_{F}L_{C}. In one example, the first time domain index of a resource is such that first time domain index % L_{T} is zero, % is the modulus operator. In one example, the first frequency domain index of a resource is such that first frequency domain index % L_{F} is zero, % is the modulus operator. In one example, the first code/comb domain index of a resource is such that first code/comb domain index % L_{C} is zero, % is the modulus operator.

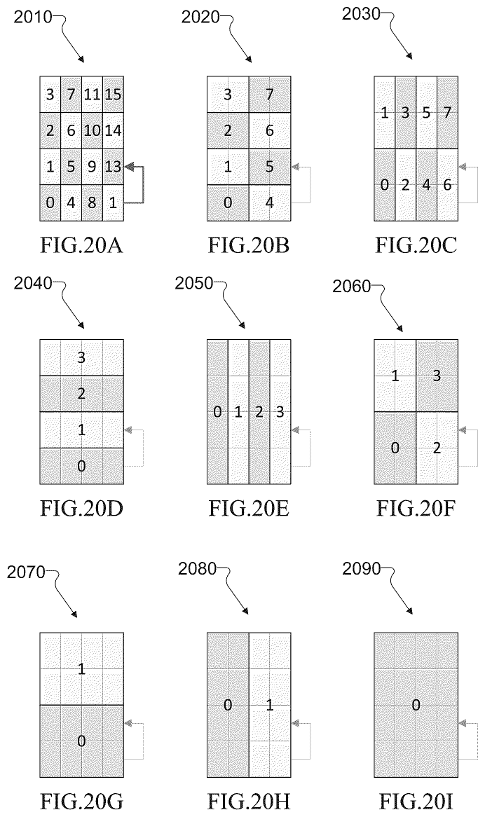

FIGS. 20A, 20B, 20C, 20D, 20E, 20F, 20G, 20H, and 20I illustrate diagrams of example aggregation levels 2010, 2020, 2030, 2040, 2050, 2060, 2070, 2080, and 2090, respectively, according to embodiments of the present disclosure. For example, aggregation levels 2010, 2020, 2030, 2040, 2050, 2060, 2070, 2080, and 2090, respectively, can be monitored by any of the UEs of FIG. 1, such as the UE 116. This example is for illustration only and other embodiments can be used without departing from the scope of the present disclosure.

FIG. 20A-FIG. 20I illustrates examples of different aggregation levels. The resources in this case are first stage/part control information resources. In FIG. 20A, a first stage/part control information region is 4 time resources (M=4) by 4 frequency resources (N=4). FIG. 20A shows an example of 16 resources with aggregation level L=1 (L_{T}=1 and L_{F}=1). FIG. 20B shows an example of 8 resources with aggregation level L=2 (L_{T}=2 and L_{F}=1). FIG. 20C shows an example of 8 resources with aggregation level L=2 (L_{T}=1 and L_{F}=2). FIG. 20D shows an example of 4 resources with aggregation level L=4 (L_{T}=4 and L_{F}=1). FIG. 20E shows an example of 4 resources with aggregation level L=4 (L_{T}=1 and L_{F}=4). FIG. 20F shows an example of 4 resources with aggregation level L=4 (L_{T}=2 and L_{F}=2). FIG. 20G shows an example of 2 resources with aggregation level L=8 (L_{T}=4 and L_{F}=2). FIG. 20H shows an example of 2 resources with aggregation level L=8 (L_{T}=2 and L_{F}=4). FIG. 20I shows an example of 1 resource with aggregation level L=16 (L_{T}=4 and L_{F}=4). In the examples of FIG. 20A-FIG. 20I, the mapping order of the aggregated resources is ascending order of frequency followed by ascending order of time. However, it should be apparent the mapping could be in ascending or descending order of time first and frequency second, or frequency first and time second as mentioned herein.

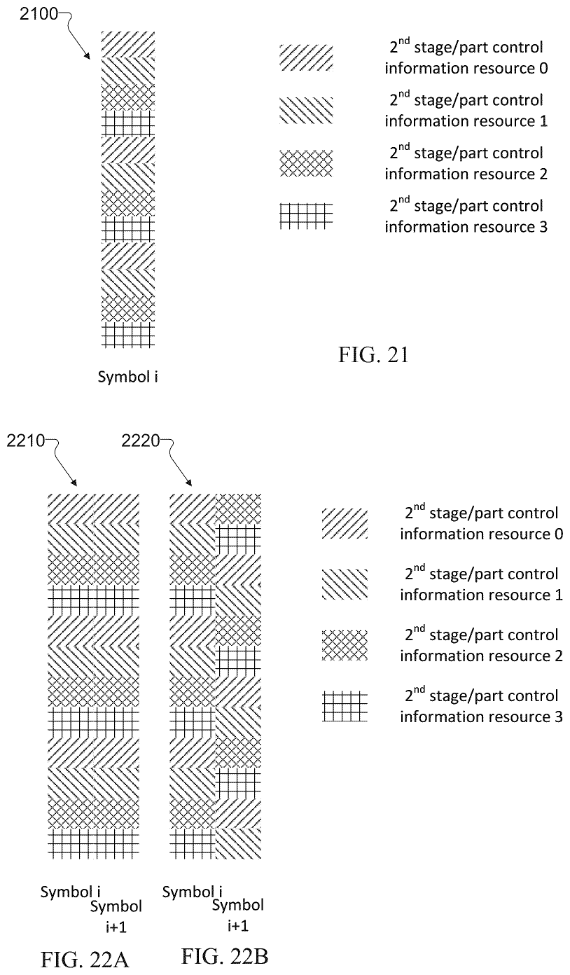

FIG. 21 illustrates a diagram for example second stage/part control information resources 2100 according to embodiments of the present disclosure (second stage/part control information region). For example, second stage/part control information resources 2100 can be utilized by the UE 111 of FIG. 1. This example is for illustration only and other embodiments can be used without departing from the scope of the present disclosure.

FIGS. 22A and 22B illustrate diagrams for example second stage/part control information resources 2210 and 2220, respectively, according to embodiments of the present disclosure. For example, second stage/part control information resources 2210 and 2220, respectively, can be utilized by the UE 116 of FIG. 3. This example is for illustration only and other embodiments can be used without departing from the scope of the present disclosure.

In one example, the second stage/part control information can be transmitted in a second stage/part control information region, wherein the second stage/part control information region can include multiple resources, wherein a resource can be determined by one more of the following:
Frequency domain resources, for example one or more physical resource blocks (PRBs) or one or more sub-carriers, or subchannels or different comb offsets. In one example, the second stage/part control information is transmitted in a resource that has a comb-N, where every Nth sub-carrier or every Nth PRB or every Nth RB group (RBG or sub-channel) is used for the second stage/part control information resource. Different second stage/part control information resources can have different comb offsets as illustrated in FIG. 21. FIG. 21 is an example, of a second stage/part control information resources with a comb-N structure, N=4 (for example), N (e.g., 4) different second stage/part control information resources are illustrated. In FIG. 21, a single symbol is used for the second stage/part control information resource. FIG. 22 is an example, of a second stage/part control information resources with a comb-N structure, N=4 (for example), N (e.g., 4) different second stage/part control information resources are illustrated. In FIG. 22, two symbols are used for the second stage/part control information resource. In FIG. 22A for a same second stage/part control information resource a same comb offset is used in the two symbols. In FIG. 22B for a same second stage/part control information resource a different comb offset is used in the two symbols, the comb offsets are staggered. The examples, of FIG. 22 can be extended to more symbols.
Time domain resources, for example, one or more symbols or one or more slots
Code domain resources, for example a scrambling code. In one example, the scrambling code can depend at least on UE identity or group UE identity or RNTI, for example, the scrambling code is initialized at least based on UE identity or group UE identity or RNTI.

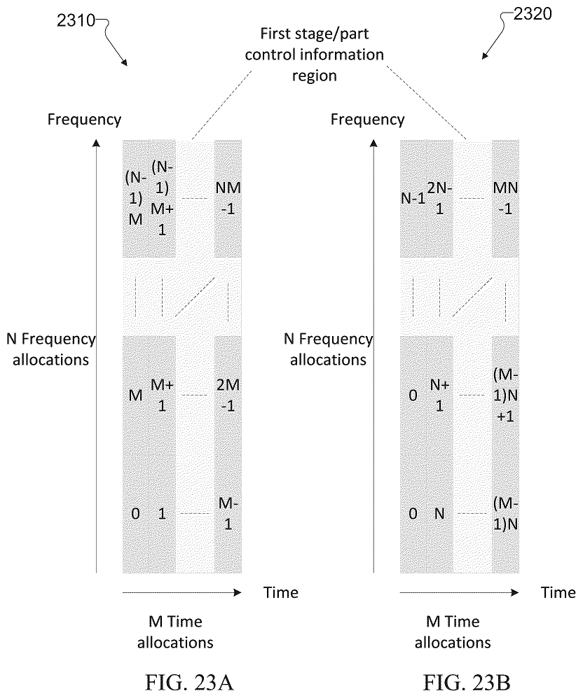

FIGS. 23A and 23B illustrate example time/frequency resource allocations 2310 and 2320, respectively, for time/frequency resource allocations according to embodiments of the present disclosure. For example, timelines 2310 and 2320, respectively, for time/frequency resource allocations can be followed by any of the UEs 111-116 of FIG. 1, such as the UE 111. This example is for illustration only and other embodiments can be used without departing from the scope of the present disclosure.

With reference to FIG. 23, an example of a second stage/part control information region that includes M time allocations for time domain resources for second stage/part control information resources and N frequency allocations for frequency domain resources for second stage/part control information resources is shown. A time-frequency resource can be T time units, and F frequency units. In one example, a time unit is a symbol. In one example, a time unit is a slot. In one example, a time unit is a subframe. In one example, a time unit is a frame. In one example, frequency unit is a sub-carrier. In one example, a frequency unit is a physical resource block (PRB) (e.g., 12 sub-carriers). In one example, a frequency unit is a sub-channel. T and F can be specified in the system specifications and/or configured or updated by higher signaling (e.g., UE dedicated signaling and/or cell-specific SIB signaling) and/or MAC CE signaling and/or L1 control (e.g., DCI Format) signaling. There can be M·N second stage/part control information resources. In one example, a second stage/part control information resource can be allocated to one of the M·N resources of FIG. 23. In one example, the resources are first indexed in ascending order of time resource and then ascending order of frequency resource as illustrated in FIG. 23A. In one example, the resources are first indexed in ascending order of frequency resource and then ascending order of time resource as illustrated in FIG. 23B.

In one example, the resources are first indexed in descending order of time resource and then descending order of frequency resource. In one example, the resources are first indexed in descending order of frequency resource and then descending order of time resource.

In one example, the resources are first indexed in ascending order of time resource and then descending order of frequency resource. In one example, the resources are first indexed in descending order of frequency resource and then ascending order of time resource.

In one example, the resources are first indexed in descending order of time resource and then ascending order of frequency resource. In one example, the resources are first indexed in ascending order of frequency resource and then descending order of time resource.

In a variant example, of FIG. 23, each time-frequency resource of FIG. 23, include K resources that can be used for second stage/part control information resources. In one example, the K resources can correspond to different comb offsets. In one example, the K resources can correspond to different code-domain resources (for example different scrambling sequences). In one example, the K resources can correspond to combination of different comb offsets and/or different code-domain resources (for example different scrambling sequences). The indexing of the first stage/part control information resources can be in ascending or descending order of a time domain or frequency domain or code/comb domain resources and in the following order according to one of the following:
First code/comb domain, then time domain, then frequency domain.
First code/comb domain, then frequency domain, then time domain.
First time domain, then code/comb domain, then frequency domain.
First time domain, the frequency domain, then code/comb domain.
First frequency domain, then code/comb domain, then time domain.
First frequency domain, the time domain, then code/comb domain.

In one example, as mentioned herein, a second stage/part control information resource can be allocated to one resource in the second stage/part control information region.

In one example, a second stage/part control information resource can be allocated to L resources in the second stage/part control information region. For example, an aggregation level of L. In one example, a second stage/part control information resource can be allocated L_{T} time domain resources in the second stage/part control information region. In one example, a second stage/part control information resource can be allocated L_{F} frequency domain resources in the second stage/part control information region. In one example, a second stage/part control information resource can be allocated L_{C} code and/or comb domain resources in the second stage/part control information region. In one example, L=L_{T}L_{F}L_{C}. In one example, the first time domain index of a resource is such that first time domain index % L_{T} is zero, % is the modulus operator. In one example, the first frequency domain index of a resource is such that first frequency domain index % L_{F} is zero, % is the modulus operator. In one example, the first code/comb domain index of a resource is such that first code/comb domain index % L_{C} is zero, % is the modulus operator. FIG. 20 shows examples of different aggregation levels. The resources in this case, are second stage/part control information resources.

In the above examples, a second stage/part control information region can contain resources for second stage/part control information and higher layer data (e.g., shared channel).

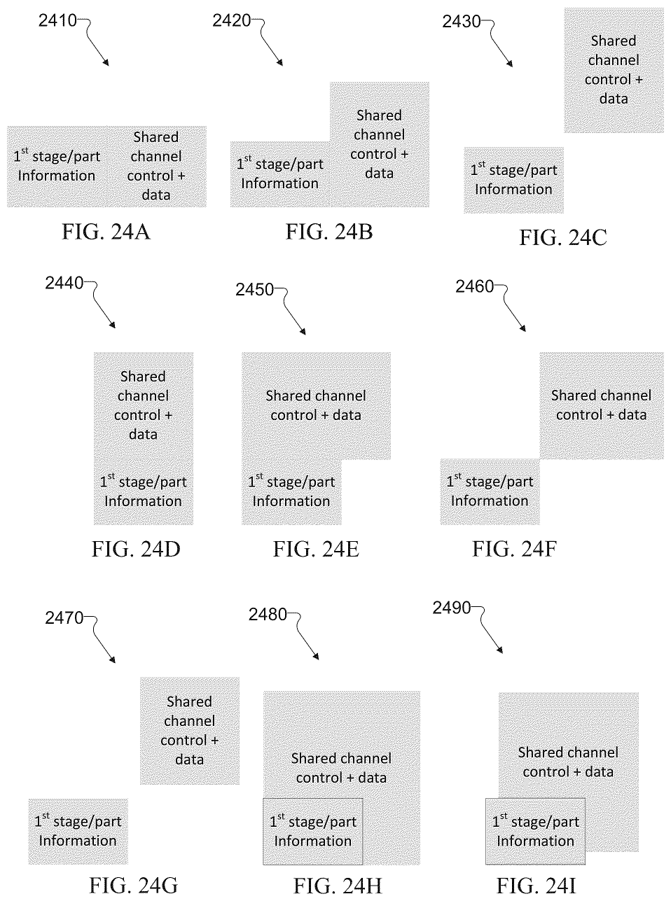

FIGS. 24A, 24B, 24C, 24D, 24E, 24F, 24G, 24H, and 24I illustrate diagrams of an example two-stage DCI 2410, 2420, 2430, 2440, 2450, 2460, 2470, 2480, and 2490, respectively, according to embodiments of the present disclosure. For example, two-stage DCI 2410, 2420, 2430, 2440, 2450, 2460, 2470, 2480, and 2490, respectively, can be received by any of the UEs 111-116 of FIG. 1, such as the UE 115. This example is for illustration only and other embodiments can be used without departing from the scope of the present disclosure.

In one example, the first stage/part and the second stage part are time and/or frequency division multiplexed, and the second stage/part control information is multiplexed in a shared channel (e.g., physical downlink shared channel (PDSCH) or similar channel) with higher later provided data (the higher layer data can be transmitted in a shared channel) as illustrated in the examples of FIG. 24.

In one example, the first stage/part control information and the second stage/part control information with higher layer data are time division multiplexed and have the same frequency span, as illustrated in FIG. 24A.

In one example, the first stage/part control information and the second stage/part control information with higher layer data are time division multiplexed and can have different frequency spans, as illustrated in FIG. 24 B and FIG. 24C.

In one example, the frequency span of the first stage/part control information and the frequency span of the second stage/part control information with higher layer data overlap as illustrated in FIG. 24B.

In one example, the frequency span of the first stage/part control information and the frequency span of the second stage/part control information with higher layer data don't overlap as illustrated in FIG. 24C.

In one example, the start frequency of the first stage/part control information and the start frequency of the second stage/part control information with higher layer data are the same as illustrated in FIG. 24B.

In one example, the start frequency of the first stage/part control information and the end frequency of the second stage/part control information with higher layer data are the same.

In one example, the end frequency of the first stage/part control information and the start frequency of the second stage/part control information with higher layer data are the same.

In one example, the end frequency of the first stage/part control information and the end frequency of the second stage/part control information with higher layer data are the same.

In one example, the start frequency of the first stage/part control information is larger than the start frequency of the second stage/part control information with higher layer data.

In one example, the start frequency of the first stage/part control information is smaller than the start frequency of the second stage/part control information with higher layer data.

In one example, the start frequency of the first stage/part control information is larger than the end frequency of the second stage/part control information with higher layer data.

In one example, the start frequency of the first stage/part control information is smaller than the end frequency of the second stage/part control information with higher layer data.

In one example, the end frequency of the first stage/part control information is larger than the start frequency of the second stage/part control information with higher layer data.

In one example, the end frequency of the first stage/part control information is smaller than the start frequency of the second stage/part control information with higher layer data.

In one example, the end frequency of the first stage/part control information is larger than the end frequency of the second stage/part control information with higher layer data.

In one example, the end frequency of the first stage/part control information is smaller than the end frequency of the second stage/part control information with higher layer data.

In one example, the time duration of the first stage/part control information and the time duration of the second stage/part control information with higher layer data are the same.

In one example, the time duration of the first stage/part control information and the time duration of the second stage/part control information with higher layer data can be different.

In one example, the first stage/part control information and the second stage/part control information with higher layer data are in a same time unit, wherein a time unit can be a symbol or N-symbols, or a slot, or N-slots, or a sub-frame, or N sub-frames or a frame or N-frames, N can be specified in the system specifications and/or configured or updated by RRC signaling and/or MAC CE signaling and/or L1 control (e.g., DCI Format) signaling.

In one example, the first stage/part control information and the second stage/part control information with higher layer data are in different time units, wherein a time unit can be a symbol or N-symbols, or a slot, or N-slots, or a sub-frame, or N sub-frames or a frame or N-frames, N can be specified in the system specifications and/or configured or updated by RRC signaling and/or MAC CE signaling and/or L1 control (e.g., DCI Format) signaling.

In one example, the first stage/part control information and the second stage/part control information with higher layer data have the same time duration, as illustrated in FIG. 24D.

In one example, the first stage/part control information and the second stage/part control information with higher layer data can have different time durations, as illustrated in FIG. 24 F.

In one example, the time duration of the first stage/part control information and the time duration of the second stage/part control information with higher layer data overlap as illustrated in FIG. 24E.

In one example, the time duration of the first stage/part control information and the time duration of the second stage/part control information with higher layer data don't overlap as illustrated in FIG. 24F.

In one example, the start time of the first stage/part control information and the start time of the second stage/part control information with higher layer data are the same as illustrated in FIG. 24E.

In one example, the start time of the first stage/part control information and the end time of the second stage/part control information with higher layer data are the same.

In one example, the end time of the first stage/part control information and the start time of the second stage/part control information with higher layer data are the same.

In one example, the end time of the first stage/part control information and the end time of the second stage/part control information with higher layer data are the same.

In one example, the start time of the first stage/part control information is larger than the start time of the second stage/part control information with higher layer data.

In one example, the start time of the first stage/part control information is smaller than the start time of the second stage/part control information with higher layer data.

In one example, the start time of the first stage/part control information is larger than the end time of the second stage/part control information with higher layer data.

In one example, the start time of the first stage/part control information is smaller than the end time of the second stage/part control information with higher layer data.

In one example, the end time of the first stage/part control information is larger than the start time of the second stage/part control information with higher layer data.

In one example, the end time of the first stage/part control information is smaller than the start time of the second stage/part control information with higher layer data.

In one example, the end time of the first stage/part control information is larger than the end time of the second stage/part control information with higher layer data.

In one example, the end time of the first stage/part control information is smaller than the end time of the second stage/part control information with higher layer data.

In one example, the frequency span of the first stage/part control information and the frequency span of the second stage/part control information with higher layer data are the same.

In one example, the frequency span of the first stage/part control information and the frequency span of the second stage/part control information with higher layer data can be different.

In one example, as illustrated in the example of FIG. 24G, the time and frequency resources of the first stage/part control information and the second stage/part control information with higher layer don't overlap.

In one example, as illustrated in the example of FIG. 24H and FIG. 24I, the time and frequency resources of the first stage/part control information and the second stage/part information with higher layer can overlap.

In one example, as illustrated in the example of FIG. 24H and FIG. 24I, there is no frequency gap and/or time gap between first stage/part control information and the second stage/part control information with higher layer.

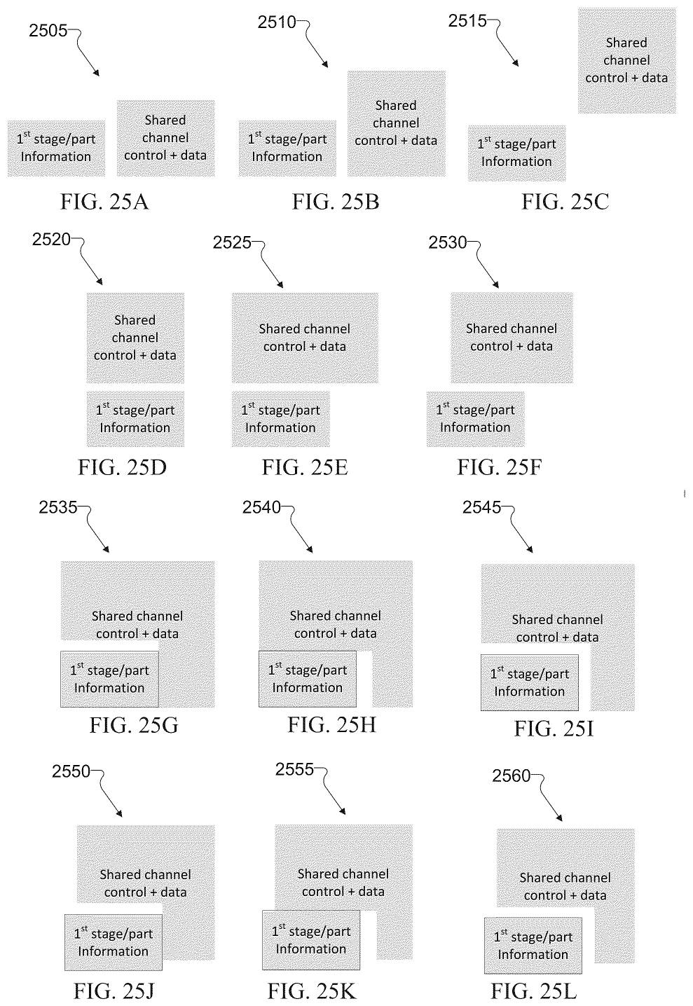

FIGS. 25A, 25B, 25C, 25D, 25E, 25F, 25G, 25H, 25I, 25J, 25K, and 25L illustrate diagrams of an example two-stage DCI 2505, 2510, 2515, 2520, 2525, 2530, 2535, 2540, 2545, 2550, 2555, and 2560, respectively, according to embodiments of the present disclosure. For example, two-stage DCI 2505, 2510, 2515, 2520, 2525, 2530, 2535, 2540, 2545, 2550, 2555, and 2560, respectively, can be received by any of the UEs 111-116 of FIG. 1, such as the UE 111. This example is for illustration only and other embodiments can be used without departing from the scope of the present disclosure.

In one example, there is a frequency gap and/or time gap between the first stage/part control information and the second stage/part control information with shared data as illustrated in FIG. 24G and the examples of FIG. 25, wherein one or more of the following can be configured or indicated or updated to the UE:
Frequency, F, between the start of the first stage/part of control information channel or signal and the start of the second stage/part of control information with shared data channel or signal.
Frequency, F, between the end of the first stage/part of control information channel or signal and the start of the second stage/part of control information with shared data channel or signal.
Frequency, F, between the end of the first stage/part of control information channel or signal and the end of the second stage/part of control information with shared data channel or signal.
Frequency, F, between the start of the first stage/part of control information channel or signal and the end of the second stage/part of control information with shared data channel or signal.
Frequency, F, between the start of the first stage/part of control information region (as described herein in this disclosure) and the start of the second stage/part of control information with shared data channel or signal.
Frequency, F, between the end of the first stage/part of control information region (as described herein in this disclosure) and the start of the second stage/part of control information with shared data channel or signal.
Frequency, F, between the end of the first stage/part of control information region (as described herein in this disclosure) and the end of the second stage/part of control information with shared data channel or signal.
Frequency, F, between the start of the first stage/part of control information region (as described herein in this disclosure) and the end of the second stage/part of control information with shared data channel or signal.
Time, T, between the start of the first stage/part of control information channel or signal and the start of the second stage/part of control information with shared data channel or signal.
Time, T, between the end of the first stage/part of control information channel or signal and the start of the second stage/part of control information with shared data channel or signal.
Time, T, between the end of the first stage/part of control information channel or signal and the end of the second stage/part of control information with shared data channel or signal.
Time, T, between the start of the first stage/part of control information channel or signal and the end of the second stage/part of control information with shared data channel or signal.
Time, T, between the start of the first stage/part of control information region (as described herein in this disclosure) and the start of the second stage/part of control information with shared data channel or signal.
Time, T, between the end of the first stage/part of control information region (as described herein in this disclosure) and the start of the second stage/part of control information with shared data channel or signal.
Time, T, between the end of the first stage/part of control information region (as described herein in this disclosure) and the end of the second stage/part of control information with shared data channel or signal.
Time, T, between the start of the first stage/part of control information region (as described herein in this disclosure) and the end of the second stage/part of control information with shared data channel or signal.

In one example, F and/or T can be specified in the system specifications and/or configured or updated by higher signaling (e.g., UE (e.g., the UE 116) dedicated signaling and/or cell-specific SIB signaling) and/or MAC CE signaling and/or L1 control (e.g., DCI Format) signaling.

In one example, F and/or T can be indicated or determined by the first stage/part control information.

In one example, F and/or T can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) frequency of the 2^{nd} stage/part control information with shared data can be indicated or determined by the first stage/part control information.

In one example, starting (or ending) time of the 2^{nd} stage/part control information with shared data can be indicated or determined by the first stage/part control information.

In one example, starting (or ending) frequency of the 2^{nd} stage/part control information with shared data can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, starting (or ending) time of the 2^{nd} stage/part control information with shared data can be determined based on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In one example, the resource used for the second stage/part control information with shared data can be indicated or determined by the first stage/part control information.

In one example, the resource used for the second stage/part control information with shared data is determined based at least on a resource of the first stage/part control information and a mapping rule, wherein the mapping rule can be specified in the system specifications and/or configured or updated by higher signaling (e.g., UE dedicated signaling and/or cell-specific SIB signaling) and/or MAC CE signaling and/or L1 control (e.g., DCI Format) signaling.

In FIGS. 24 and 25 while the first stage/part of control information is shown to have a lower frequency than the second stage/part of control information, the order can be reversed such that the first stage/part of control information has a higher frequency than the second stage/part of control information.

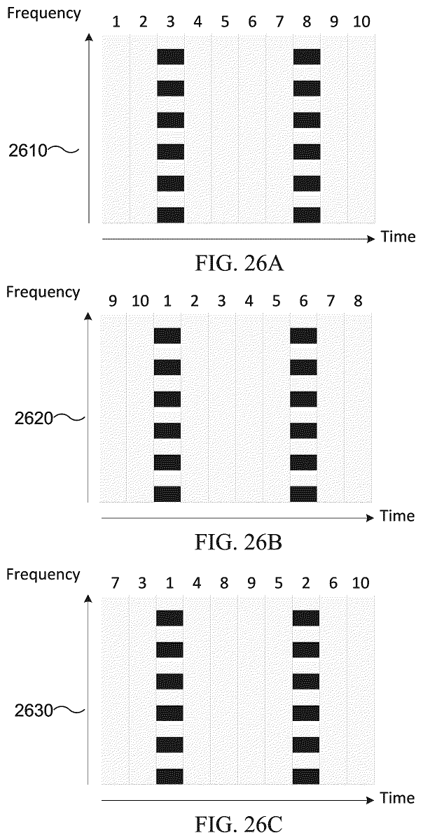

FIGS. 26A, 26B, and 26C illustrate example timelines 2610, 2620, and 2630, respectively, for mapping second stage control information according to embodiments of the present disclosure. For example, timelines 2610, 2620, and 2630, respectively, for mapping second stage control information can be followed by any of the UEs 111-116 of FIG. 1, such as the UE 116 of FIG. 3. This example is for illustration only and other embodiments can be used without departing from the scope of the present disclosure.

In one example, the second stage control information and higher layer data (shared channel) are mapped to a same physical channel. In one example, the physical channel includes multiple symbols. In one example, the physical channel includes D demodulation reference signal (DMRS) symbols (i.e., symbols with DMRS resource elements).
In one example, as illustrated in FIG. 26A, the second stage control information after encoding and rate matching is mapped to resource elements not used for DMRS starting with the resource elements of the first symbol in ascending order of frequency resources (sub-carriers) followed by ascending order of time resources (symbols). After the second stage control information is mapped the shared channel is mapped to remaining resource elements (not used for DMRS) in order of frequency resources (sub-carriers) followed by ascending order of time resources (symbols). In variant example, DMRS symbols are not used to map second stage/part control information.
In one example, as illustrated in FIG. 26B, the second stage control information after encoding and rate matching is mapped to resource elements not used for DMRS starting with the resource elements of the first DMRS symbol, if any, in ascending order of frequency resources (sub-carriers) followed by ascending order of time resources (symbols). After the second stage control information is mapped the shared channel is mapped to remaining resource elements (not used for DMRS) in order of frequency resources (sub-carriers) followed by ascending order of time resources (symbols). In variant example, DMRS symbols are not used to map second stage/part control information.
In one example, as illustrated in FIG. 26C, the symbols used for second stage control information are the following order:
   DMRS symbols starting from the first DMRS symbol to last DMRS symbols, if any. In variant example, DMRS symbols are not used to map second stage/part control information.
   Symbols adjacent to DMRS symbols, if any, starting from symbol before the first DMRS symbol, then symbol after first DMRS symbol, the symbol before the second the DMRS symbol, then symbol after the second DMRS symbol . . . to symbol after last DMRS symbol.
   Second symbols adjacent to DMRS symbols, if any, starting from second symbol before the first DMRS symbol, then second symbol after first DMRS symbol, then second symbol before the second the DMRS symbol, then second symbol after the second DMRS symbol . . . to second symbol after last DMRS symbol.
   . . . .

The second stage control information after encoding and rate matching is mapped to resource elements not used for DMRS in the order mentioned herein in ascending order of frequency resources (sub-carriers) with each symbol. After the second stage control information is mapped the shared channel is mapped to remaining resource elements (not used for DMRS) in order of frequency resources (sub-carriers) followed by ascending order of time resources (symbols).

With reference to FIG. 26, the number on top of each symbol is the order using this symbol to made resource elements associated with second stage/part control information starting with number 1. The boxes in dark color correspond to resources used by DMRS.

In one example, the container for first stage/part control information is a sequence that is determined or initialized at least by a UE's identity. Wherein, the UE identity can be configured by higher layers. In one example, the UE's identity is 16-bits. In one example, the UE's identity is 24-bits. In one example, the sequence is additionally determined or initialized by the information (payload) content of the first stage/part control information.

In one example, the container for first stage/part control information is a low power wake up signal (LP-WUS) that is determined or initialized at least by a UE's identity or part of the UE's identity.

In one example, the container for first stage/part control information is a physical channel (e.g., PDCCH) that carriers the payload of the first stage/part control information. The control information can have a cyclic redundancy check (CRC) attached to it. In one example, the CRC is scrambled by UE's identity or RNTI. Wherein, the UE identity or RNTI can be configured by higher layers. In one example, the data can be further encoded and/or interleaved and/or rate-matched and mapped to resource element allocated to the first stage/part control information resource.

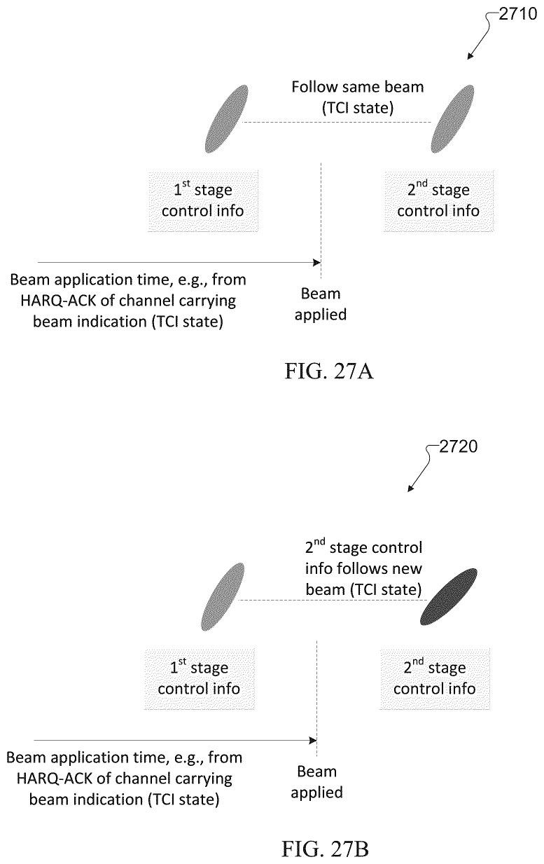

FIGS. 27A and 27B illustrate example timelines 2710 and 2720, respectively, for updating TCI states according to embodiments of the present disclosure. For example, timelines 2710 and 2720, respectively, for updating TCI states can be followed by any of the UEs 111-116 of FIG. 1, such as the UE 111. This example is for illustration only and other embodiments can be used without departing from the scope of the present disclosure.

In one example, a same beam is used for the first stage/part control information and for the second stage/part control information. For example, this can be based on the latest indicated TCI state.

In one example, if the TCI state is updated between the first stage/part control information and the second stage part control information, the second stage/part control information continues to follow the TCI state used by the first stage/part control information as illustrated in FIG. 27A.

In one example, if the TCI state is updated between the first stage/part control information and the second stage part control information, the second stage/part control information follows the updated TCI state as illustrated in FIG. 27B. In a variant of FIG. 27B, if the time between the first stage/part control information and the second stage/part control information is less than (or less than or equal to) a threshold, the second stage/part control information follows the beam of the first stage/part control information. If the time between the first stage/part control information and the second stage/part control information is greater than (or greater than or equal to) a threshold, the second stage/part control information follows the updated TCI state. Wherein, the threshold can be specified in the system specifications and/or configured or updated by higher signaling (e.g., UE dedicated signaling and/or cell-specific SIB signaling) and/or MAC CE signaling and/or L1 control (e.g., DCI Format) signaling.

In one variant for the examples of FIG. 27, the second stage control information is in a channel or signal (e.g. PDCCH or PDSCH) with no higher layer data shared channel.

In another variant for the examples of FIG. 27, the second stage control information is in a channel (e.g., PDSCH) with higher layer data shared channel.

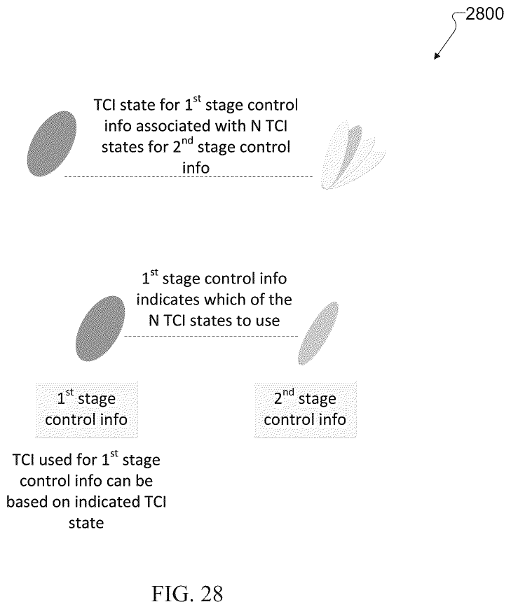

FIG. 28 illustrates a diagram of an example first and second stage/part control information 2800 according to embodiments of the present disclosure. For example, first and second stage/part control information 2800 can be received by any of the UEs 111-116 of FIG. 1, such as the UE 112. This example is for illustration only and other embodiments can be used without departing from the scope of the present disclosure.

In one example, a beam is used for the first stage/part control information, the first stage/part control information includes a beam index, wherein the beam of the second stage/part control information depends on the beam of the first stage/part control information and the beam index. A first stage uses a wide beam, and a second stage uses a narrow beam within the wide beam. In one example, the beam for the first stage/part control information is (e.g., a wide beam) (e.g., based on the indicated TCI state). Associated with the beam of the indicated TCI state are N beams (e.g., narrow beams). The first stage/part control information can include an indication of one of the N beams to be use with second stage/part control channel and/or the higher layer data shared channel as illustrated in FIG. 28. In a variant of FIG. 28, if the time between the first stage/part control information and the second stage/part control information is less than (or less than or equal to) a threshold, the second stage/part control information follows the beam of the first stage/part control information. If the time between the first stage/part control information and the second stage/part control information is greater than (or greater than or equal to) a threshold, the second stage/part control information follows the beam indicated in the first stage/part control information. Wherein, the threshold can be specified in the system specifications and/or configured or updated by higher signaling (e.g., UE dedicated signaling and/or cell-specific SIB signaling) and/or MAC CE signaling and/or L1 control (e.g., DCI Format) signaling.

In one variant for the example of FIG. 28, the second stage control information is in a channel or signal with no higher layer data shared channel.

In another variant for the example of FIG. 28, the second stage control information is in a channel with higher layer data shared channel.

In one example, a beam can be associated with an SSB resource or CSI-RS resource or SRS resource.

In one example, a beam can be associated with a port of CSI-RS resource.

In one example a payload of the first stage/part control information or the first stage/part control information can indicate one or more of the following
UE ID.
   In one example, the control information is dedicated to a UE, for example, the first stage/part control information is associated with a second stage/part control information that is intended for a UE. The first stage/part control information can include or indicate a user identity (e.g., UE ID) or a radio network temporary identifier (RNTI) associated with the UE, wherein, the UE ID and/or the RNTI is configured and/or updated by RRC signaling and/or MAC CE signaling and/or L1 control signaling.
   In one example, the control information is for a group of UEs, for example, the first stage/part control information is associated with a second stage/part control information that is intended for a group of UEs. The first stage/part control information can include or indicate a group user identity (e.g., group UE ID) or a radio network temporary identifier (RNTI) associated with the group of UEs, wherein, the group UE ID and/or the RNTI is configured and/or updated by RRC signaling and/or MAC CE signaling and/or L1 control (e.g., DCI Format) signaling.
   In one example, the control information is for UEs in a cell or in the network (e.g., attached to the network and/or within the coverage area of the network), for example, the first stage/part control information is associated with a second stage/part control information that is intended for UEs in a cell or UEs in a network. The first stage/part control information can include or indicate an identity for such UEs (cell-based ID or network-based ID) or a radio network temporary identifier (RNTI) associated with UEs in a cell or UEs in a network, wherein, the cell-based ID or network-based ID and/or the RNTI is configured and/or updated by RRC signaling and/or MAC CE signaling and/or L1 control signaling.
Size of second stage/part control information. In one example, N different sizes of the second stage/part control information are specified or configured/updated by RRC signaling and/or MAC CE signaling and/or L1 control signaling. The first stage/part control information can indicate one of the N sizes used for the associated second stage/part control information.
Type of second stage/part control information. In one example, N different types of the second stage/part control information are specified or configured/updated by RRC signaling and/or MAC CE signaling and/or L1 control signaling. The second stage/part control information can indicate one of the N types used for the associated second stage/part control information. In one example, a type can determine a size of the second stage/part control information.
Beam indication.
   In one example, the beam indication is a unified TCI state (e.g., Joint TCI state or separate UL and/or DL TCI state) for data and control channels.
   In one example, the beam indication is a beam indication for the second stage/part control information as mentioned herein.
Resources used for a signal or channel conveying the second stage/part control information or for a channel conveying the second stage/part control information and shared channel.
   In one example, a time offset and/or frequency offset between the first stage/part control information signal or channel and the resource carrying the second stage/part control information and possibly a shared channel is indicated.
   In one example, a time offset and/or frequency offset between the first stage/part control information region (e.g., start or end of such region) and the resource carrying the second stage/part control information and possibly a shared channel is indicated.
   In one example, a starting time resource and/or a starting frequency for the resource carrying the second stage/part control information and possibly a shared channel is indicated.
   In one example, a frequency span and/or a time duration for the resource carrying the second stage/part control information and possibly a shared channel is indicated.
PDCCH skipping indication, to skip blind decoding of future instances of 1st stage DL control information.

In one example, a UE may trigger UE initiated reporting in response to the first stage/part control information.

In one example, a UE may trigger UE initiated reporting in response to the second stage/part control information.

According to the embodiments of this disclosure:
A UE may be configured to operate with two stage/part control information.
A UE receives configuration information for resources for a first stage/part control information.
1 A UE receives an identifier (e.g., UE ID, group ID, cell-based ID, network-based, RNTI) associated with first stage/part control information intended for the UE.
UE monitors first stage/part control information by receiving and decoding first stage/part control information resources or aggregated resources. UE may receive configuration information regarding the aggregation levels to monitor. Higher aggregation levels can provide better coverage, while lower aggregation levels are more resource efficient when coverage is not an issue.
UE determines a first stage/part control information intended for it.
UE determines resources, TCI state (beam) and decoding parameters (e.g., payload size), etc. associated with the second stage/part control information, based on payload of first stage/part control information and/or resource of first stage/part control information and/or higher layer configuration parameters.
UE receives and decodes second stage/part control information.

Quasi-co-location (QCL) relation, can be quasi-location with respect to one or more of the following relations [38.214-section 5.1.5] [REF4]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. An UE is indicated a TCI state by a DL related DCI format (e.g., DCI Format 1_1, or DCI format 1_2), wherein the DCI format includes a “transmission configuration indication” field that includes a TCI state code point out of the TCI state code points active by a MAC CE. A DL related DCI format can be used to indicate a TCI state when the UE is activated with more than one TCI state code points. The DL related DCI Format can be with a DL assignment or without a DL assignment. A TCI state (TCI state code point) indicated in a DL related DCI format is applied after a beam application time from the corresponding HARQ-ACK feedback.

In this disclosure, two stage/part control information is provided. Where, the first stage/part control information can have a fixed and/or small payload size, with a low reception and decoding complexity on the UE side. The first stage can be transmitted using different spatial filters or beams, this allows the UE to determine a prefer spatial filter or beam for sub-sequent transmission. In one example, based on the outcome of the first stage/part control information decoding, a UE can decide whether or not proceed with the second stage/part control information decoding. In one example, the UE provides feedback to the network (e.g., the network 130) based on the first stage/part decoding, wherein the feedback can indicate a preferred spatial filter for subsequent transmissions and receptions. In this disclosure, aspects related to the structure of the two stage/part control information including the feedback information from the UE to the network are provided.

In 5G/NR, downlink control information (DCI) is carried by physical downlink control channel (PDCCH). A DCI can include scheduling information for DL, UL or SL data, as well as other types of control information. The UE continuously monitors PDCCH candidates, to determine control information intended for it. This is done by blind decoding the PDCCH candidates, to limit UE's computation complexity, the number of PDCCH candidates that require blind decoding per-slot is limited to M_{PDCCH}^{max,μ}={44,36,22,20}, for sub-carrier spacing (SCS) configuration μ of {0,1,2,3} respectively. In 5G/NR, the DCI size budget limited by “3+1”, with a limited number of decode hypothesis. Despite this, the UE power consumption due to control channel processing is high. Over 98% of the UE's power consumption is consumed for control channel monitoring [Evolution of Power Saving Techniques for 5G New Radio, Kim et. al,]. To reduce the computation complexity of the UE's reception and decoding procedures, having a fixed size control information channel and/or a control information channel with a small payload will be beneficial. For example, by having a fixed size control channel information, the number of decoding hypothesis can be reduced (a single size is decoded blindly by the UE). By having a small payload for the control information, the decoding complexity of the UE is reduced. In a beam based system with narrow beams (spatial filters) and/or high-mobility, beams can change rapidly. Using tradition beam management methods increases overhead and latency. To alleviate these issues, the small payload size and low complexity of the first stage/part can be leveraged by transmitting the first stage/part using multiple (and e.g., narrow) beams (spatial filters), without incurring large overhead, the UE can then identify a preferred beam and indicate that back to the network. The first stage/part control information is blind decoded by the UE, and provides necessary information on the resources and/or type and/or size of the second stage/part control information. The first stage/control information can include an indication to the UE, whether it needs to receive and decode the second stage/part control information, for example, this can be based on including or indicating in the first control stage/part control information a user identity or a radio network temporary identifier associated with the UE. The first stage/part also allows the UE to identify a preferred beam (spatial filter) for subsequent communications between the UE and network. The UE conveys the preferred beam (spatial filter) to the network.

Using two stage/part control information can lead to: (1) lower overhead due to the lower size of first stage/part control information leading to a smaller search space size without increasing blocking probability. (2) Lower UE power consumption, by reducing the complexity of blind decodes and the number of DCI formats the UE should decode in the first stage. (3) Better beam sweeping.

The present disclosure relates to a 5G/NR and/or 6G communication system.

This disclosure provides aspects related to design of two stage/part control information:
Two-stage control information, with first stage being a fixed-size low-decode complexity channel.
The first stage/part can be used for beam refinement by using multiple beams (spatial filter).
Design of feedback channel in response to the first stage/part, including beam indication aspects and the use of the feedback for beam refinement of the link from the UE to the network.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common signaling, e.g., this can be system information block (SIB)-based RRC signaling (e.g., SIB1 or other SIB) or (2) RRC dedicated signaling that is sent to a specific UE or (3) UE-group RRC signaling.

In this disclosure MAC CE signaling can be UE-specific e.g., to one UE and/or can be UE common (e.g., to a group of UEs). MAC CE signaling can be DL MAC CE signaling or UL MAC CE signaling.

In this disclosure L1 control signaling includes: (1) DL control information (e.g., DCI on PDCCH) and/or (2) UL control information (e.g., UCI on PUCCH or PUSCH). L1 control signaling can be UE-specific e.g., to one UE and/or can be UE common (e.g., to a group of UEs).

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE (e.g., the UE 116) can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one channel state information (CSI-RS) resource indicator (CRI) or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the information to assign a particular DL (or/and UL) TX beam to the UE.

In the following components, a TCI state is used for beam indication. It can refer to a DL TCI state for downlink channels or signals (e.g. PDCCH and PDSCH and CSI-RS), an uplink TCI state for uplink channels or signals (e.g. PUSCH or PUCCH or SRS), a joint TCI state for downlink and uplink channels, or separate TCI states for uplink and downlink channels. A TCI state can be common across multiple component carriers or can be a separate TCI state for a component carrier or a set of component carriers. A TCI state can be gNB or UE panel specific or common across panels. In some examples, the uplink TCI state can be replaced by SRS resource indicator (SRI).

With reference to FIG. 7, in the following examples, a UE is configured/updated through higher layer RRC signaling a set of TCI States with L elements. In one example, DL and joint TCI states are configured by higher layer parameter DLorJoint-TCIState, wherein, the number of DL and Joint TCI state is L_{DJ}. UL TCI state are configured by higher layer parameter UL-TCIState, wherein the number of UL TCI state is L_{U}. L=L_{DJ}+L_{U}, wherein L is the total number of DL, Joint and UL TCI states. In one example, DL, UL and Joint TCI states are configured by a higher layer parameter, wherein the number of DL, UL and Joint TCI state is L.

MAC CE signaling includes a subset of K (K≤L) TCI states or TCI state code points from the set of L TCI states, wherein a code point is signaled in the “transmission configuration indication” field a DCI used for indication of the TCI state. A codepoint can include one TCI state (e.g., DL TCI state or UL TCI state or Joint (DL and UL) TCI state). Alternatively, a codepoint can include two TCI states (e.g., a DL TCI state and an UL TCI state). L1 control signaling (i.e. Downlink Control Information (DCI)) updates the UE's TCI state, wherein the DCI includes a “transmission configuration indication” (beam indication) field e.g. with k bits (such that K≤2^{k}), the TCI state corresponds to a code point signaled by MAC CE. A DCI used for indication of the TCI state can be DL related DCI Format (e.g., DCI Format 1_1 or DCI Format 1_2), with a DL assignment or without a DL assignment.

The TCI states can be associated, through a QCL relation, with an SSB of serving cell, or an SSB associated with a PCI different from the PCI of the serving cell. The QCL relation with a SSB can be a direct QCL relation, wherein the source RS (e.g., for a QCL Type D relation or a spatial relation) of the QCL state is the SSB. The QCL relation with a SSB can be an indirect QCL relation, wherein, the source RS (e.g., for a QCL Type D relation or a spatial relation) can be a reference signal, and the reference signal has the SSB as its source (e.g., for a QCL Type D relation or a spatial relation). The indirect QCL relation to an SSB can involve a QCL or spatial relation chain of more than one reference signal.

The UE can use a DL related DCI (e.g., DCI Format 1_1 or DCI Format 1_2) without DL assignment, for beam indication. For example, the use of DL related DCI without DL assignment, can be configured by higher layers, or can be specified in the system specification.

Alternatively, the UE can use a DL related DCI (e.g., DCI Format 1_1 or DCI Format 1_2) with DL assignment, for beam indication. For example, the use of DL related DCI with DL assignment, can be configured by higher layers, or can be specified in the system specification.

Alternatively, the UE can use an UL related DCI (e.g., DCI Format 0_1 or DCI Format 0_2) with UL grant, for beam indication. For example, the use of UL related DCI with UL grant, can be configured by higher layers, or can be specified in the system specification.

Alternatively, the UE can use an UL related DCI (e.g., DCI Format 0_1 or DCI Format 0_2) without UL grant, for beam indication. For example, the use of UL related DCI without UL grant, can be configured by higher layers, or can be specified in the system specification.

Alternatively, the UE can use a DCI, for beam indication. For example, the use DCI for beam indication, can be configured by higher layers, or can be specified in the system specification.

Alternatively, the UE can use a purpose designed channel or signal, for beam indication. For example, the use the purpose designed channel or signal for beam indication, can be configured by higher layers, or can be specified in the system specification.

In the following examples, the “transmission configuration indication” provided by a DCI format or a purpose designed channel or signal for beam indication includes a TCI state codepoint activated by MAC CE or configured by RRC. Wherein, the TCI state codepoint can be one of:
Joint TCI state used for UL transmissions and DL receptions by the UE.
DL TCI state used for DL receptions by the UE.
UL TCI state used for UL transmissions by the UE.
DL TCI state used for DL receptions by the UE and UL TCI states used for UL transmissions by the UE.

In the following examples, the “transmission configuration indication” provided by a DCI format or a purpose designed channel or signal for beam indication includes a TCI state codepoint activated by MAC CE or configured by RRC. Wherein, the TCI state codepoint can include TCI state(s) for one entity or can include TCI state(s) for multiple entities. Wherein, an entity can be one or more of the following:
A transmission reception point (TRP)
A coreset pool index
A network panel (e.g., TRP panel)
A UE panel
A cell (e.g., a cell associated with a PCI)
A component carrier
A bandwidth part (BWP)

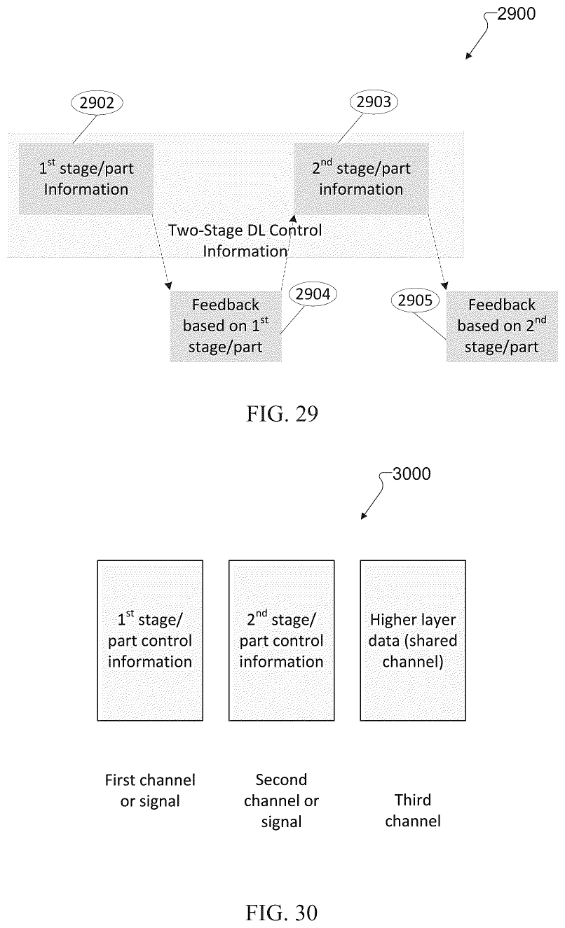

FIG. 29 illustrates a diagram of an example two-stage DCI 2900 according to embodiments of the present disclosure. For example, two-stage DCI 2900 can be received by any of the UEs 111-116 of FIG. 1, such as the UE 113. This example is for illustration only and other embodiments can be used without departing from the scope of the present disclosure.

In one example, the second stage/part control information may be absent. With reference to FIG. 29, feedback information can be provided in response to the first stage/part control information (2902) and/or in response to the second stage/part control information (2903). In one example, after the first stage/part control information (2902) is received and decoded by the UE, the UE provides feedback (2904) to network, based on the feedback provided by the UE (or the based on the presence or absence of such feedback), the network can decide or determine whether or not to proceed with the second stage/part transmission (2903), the feedback can also impact the information and/or the manner (e.g., spatial filter used) of the second stage/part transmission. In a further example, after the second stage/part control information (2903) is received and decoded by the UE, the UE provides feedback (2905) to network.

In one example, the network can configure a UE to operate using a two stages/parts for DL control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the network can configure a UE to operate using a one stage/part for DL control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the default mode of operation if the UE doesn't receive any additional signaling is one stage/part control information. The UE maybe further configured as mentioned herein to operate using two stage/part control information.

In one example, the default mode of operation if the UE doesn't receive any additional signaling is two stage/part control information. The UE maybe further configured as mentioned herein to operate using one stage/part control information.

FIG. 30 illustrates a diagram of an example two-stage DCI 3000 according to embodiments of the present disclosure. For example, two-stage DCI 3000 can be received by any of the UEs 111-116 of FIG. 1, such as the UE 114. This example is for illustration only and other embodiments can be used without departing from the scope of the present disclosure.

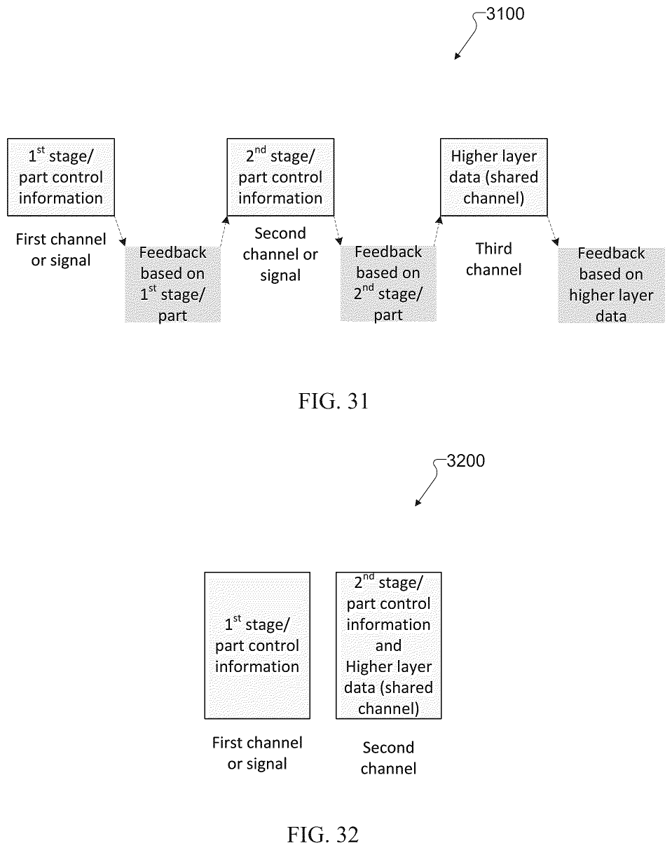

FIG. 31 31 illustrates a diagram of an example two-stage DCI 3100 according to embodiments of the present disclosure. For example, two-stage DCI 3100 can be received by any of the UEs 111-116 of FIG. 1, such as the UE 115. This example is for illustration only and other embodiments can be used without departing from the scope of the present disclosure.

In one example, the network can configure a UE with two stages/parts for DL control information to provide feedback after the first stage/part control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the default mode of operation if the UE doesn't receive any additional signaling is no feedback is provided after the first stage/part control information. The UE maybe further configured as mentioned herein to provide feedback after the first stage/part control information.

In one example, the default mode of operation if the UE doesn't receive any additional signaling is to provide feedback after the first stage/part control information. The UE maybe further configured as mentioned herein to not provide feedback after the first stage/part control information.

In one example, the network (e.g., the network 130) can configure a UE with two stages/parts for DL control information to provide feedback after the second stage/part control information. The configuration can be by one or more of
Network specific signaling, e.g., to users within a coverage area of a network.
Cell specific signaling, e.g., using a master information block (MIB) (or MIB-like) associated with a synchronization block (e.g., cell defining synchronization block).
Cell specific signaling, e.g., using a system information block (SIB).
UE-group-specific signaling, e.g., to a group of users in a cell or in a network.
UE-specific signaling, e.g., dedicated RRC signaling to a user.

In one example, the default mode of operation if the UE doesn't receive any additional signaling is no feedback is provided after the second stage/part control information. The UE maybe further configured as mentioned herein to provide feedback after the second stage/part control information.

In one example, the default mode of operation if the UE doesn't receive any additional signaling is to provide feedback after the second stage/part control information. The UE maybe further configured as mentioned herein to not provide feedback after the second stage/part control information.

In one example, the first stage/part DL control information is transmitted in a first channel or signal (e.g., PDCCH). In one example, the first stage/part DL control information is a low power wake up signal (LP-WUS). In one example, the second stage/part DL control information is transmitted in a second channel or signal (e.g., PDCCH or PDSCH). In one example, higher layer data in DL direction (e.g., higher layer shared channel, e.g., DL-SCH) is transmitted in a third channel (e.g., PDSCH) illustrated in FIG. 30. In one example, the first stage/part DL control information is transmitted in the first stage/part control information region as described herein, the second stage/part DL control information is transmitted in the second stage/part control information region as described herein and the shared channel is transmitted in resources indicated or determined by the first and/or second stage/part DL control information (e.g., outside the first stage/part control information region and the second stage/part control information region). In one example, the first stage/part DL control information is transmitted in the first stage/part control information region, the second stage/part control information is transmitted in resources indicated or determined by the first stage/part DL control information (e.g., outside the first stage/part control information region), and the shared channel is transmitted in resources indicated or determined by the first and/or second stage/part DL control information (e.g., outside the first stage/part control information region). In one example, Polar coding is used for first stage/part control information. In one example, Polar coding is used for second stage/part control information. In one example, LDPC coding is used for second stage/part control information. FIG. 31 illustrates an example with feedback after 1^{st} stage/part control information and/or feedback after 2^{nd} stage/part control information and/or feedback after higher layer data. In a variant of the example of FIG. 31, there is no feedback after 1^{st} stage/part control information. In another variant of the example of FIG. 31, additionally or alternatively, there is no feedback after 2^{nd} stage/part control information. In yet, a third variant of the example of FIG. 31, additionally or alternatively, there is no feedback after higher layer data. In one example, the feedback is provided in a physical uplink control channel (e.g., PUCCH). In one example, the feedback is provided in a physical uplink shared channel (e.g., PUSCH).

FIG. 32 illustrates a diagram of an example two-stage DCI 3200 according to embodiments of the present disclosure. For example, two-stage DCI 3200 can be received by any of the UEs 111-116 of FIG. 1, such as the UE 111. This example is for illustration only and other embodiments can be used without departing from the scope of the present disclosure.

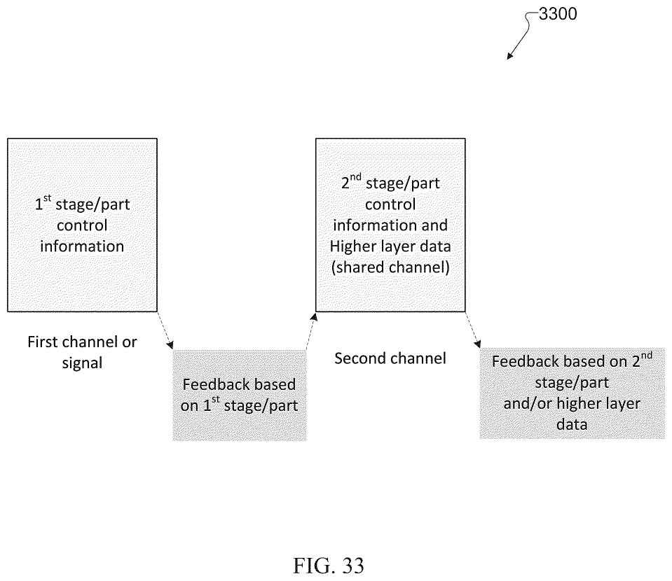

FIG. 33 illustrates a diagram of an example two-stage DCI 3300 according to embodiments of the present disclosure. For example, two-stage DCI 3300 can be received by any of the UEs 111-116 of FIG. 1, such as the UE 112. This example is for illustration only and other embodiments can be used without departing from the scope of the present disclosure.

In one example, the first stage/part DL control information is transmitted in a first channel or signal (e.g., PDCCH). In one example, the first stage/part DL control information is a low power wake up signal (LP-WUS). In one example, the second stage/part DL control information and higher layer data (e.g., higher layer shared channel, e.g., DL-SCH) are transmitted in a second channel (e.g., PDSCH) illustrated in FIG. 32. In one example, the first stage/part DL control information is transmitted in the first stage/part control information region as described herein, the second stage/part DL control information and shared channel are transmitted in the second stage/part control information region. In one example, the first stage/part DL control information is transmitted in the first stage/part control information region as described herein, the second stage/part control information and shared channel are transmitted in resources indicated or determined by the first stage/part DL control information (e.g., outside the first stage/part control information region). In one example, Polar coding is used for first stage/part control information. In one example, Polar coding is used for second stage/part control information. In one example, LDPC coding is used for second stage/part control information. FIG. 33 illustrates an example with feedback after 1^{st} stage/part control information and/or feedback after 2^{nd} stage/part control information and higher layer data. In a variant of the example of FIG. 33, there is no feedback after 1^{st} stage/part control information. In another variant of the example of FIG. 33, additionally or alternatively, there is no feedback after 2^{nd} stage/part control information and higher layer data. In yet, a third variant of the example of FIG. 33, additionally or alternatively, there is no feedback after higher layer data. In one example, the feedback is provided in a physical uplink control channel (e.g., PUCCH). In one example, the feedback is provided in a physical uplink shared channel (e.g., PUSCH).

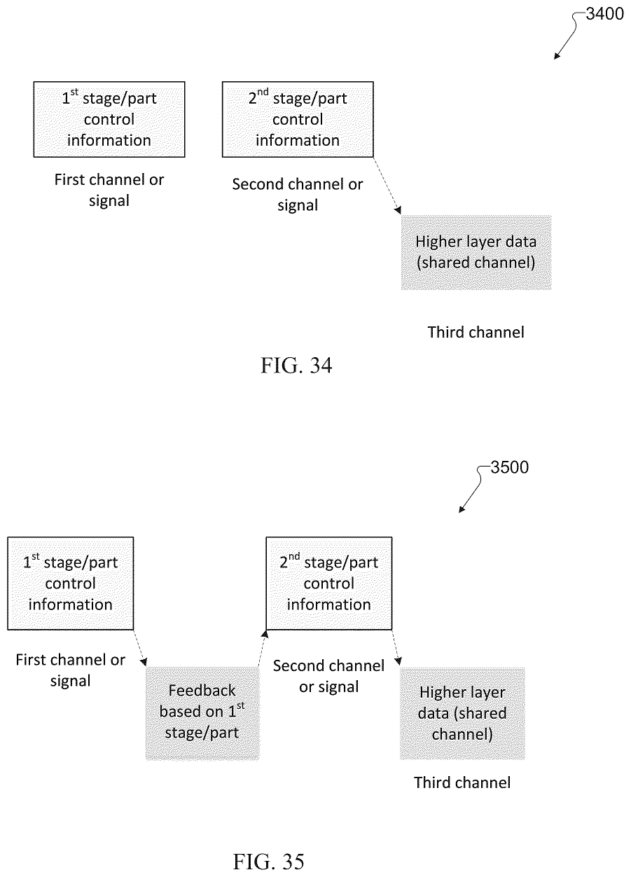

FIG. 34 illustrates a diagram of an example two-stage DCI 3400 according to embodiments of the present disclosure. For example, two-stage DCI 3400 can be received by any of the UEs 111-116 of FIG. 1, such as the UE 113. This example is for illustration only and other embodiments can be used without departing from the scope of the present disclosure.

FIG. 35 illustrates a diagram of an example two-stage DCI 3500 according to embodiments of the present disclosure. For example, two-stage DCI 3500 can be received by any of the UEs 111-116 of FIG. 1, such as the UE 114. This example is for illustration only and other embodiments can be used without departing from the scope of the present disclosure.

In one example, the first stage/part DL control information is transmitted in a first channel or signal (e.g., PDCCH). In one example, the first stage/part DL control information is a low power wake up signal (LP-WUS). In one example, the second stage/part DL control information is transmitted in a second channel or signal (e.g., PDCCH or PDSCH). In one example, higher layer data in UL direction (e.g., higher layer shared channel, e.g., UL-SCH), e.g., from UE to network, is transmitted in a third channel (e.g., PUSCH) illustrated in FIG. 34. In one example, the first stage/part DL control information is transmitted in the first stage/part control information region as described herein, the second stage/part DL control information is transmitted in the second stage/part control information region as described herein, and the shared channel is transmitted in resources indicated or determined by the first and/or second stage/part DL control information. In one example, the first stage/part DL control information is transmitted in the first stage/part control information region, the second stage/part control information is transmitted in resources indicated or determined by the first stage/part DL control information (e.g., outside the first stage/part control information region), and the shared channel is transmitted in resources indicated or determined by the first and/or second stage/part DL control information. In one example, Polar coding is used for first stage/part control information. In one example, Polar coding is used for second stage/part control information. In one example, LDPC coding is used for second stage/part control information. FIG. 35 illustrates an example with feedback after 1^{st} stage/part control information. In one example, the UL channel with higher layer shared data can be regarded as the response to the 2^{nd} stage/part control information. In a variant of the example of FIG. 35, there is no feedback after 1^{st} stage/part control information. In one example, the feedback is provided in a physical uplink control channel (e.g., PUCCH). In one example, the feedback is provided in a physical uplink shared channel (e.g., PUSCH).

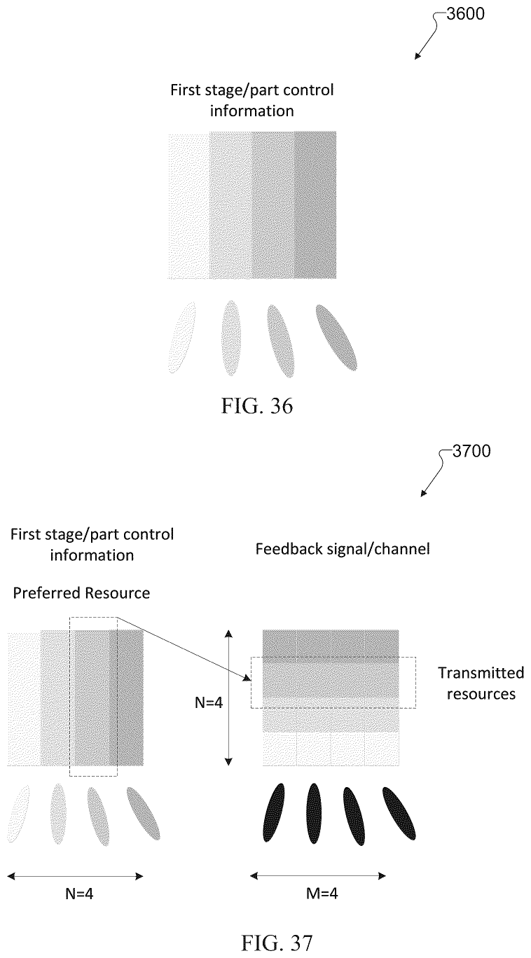

FIG. 36 illustrates a diagram of an example first stage/part control information 3600 according to embodiments of the present disclosure. For example, first stage/part control information 3600 can be received by any of the UEs 111-116 of FIG. 1, such as the UE 115. This example is for illustration only and other embodiments can be used without departing from the scope of the present disclosure.

In one example, the first stage/part control information is repeated N times, (e.g., using N resources) as illustrated in FIG. 36. In one example, the N resources are in time domain as illustrated in FIG. 36. In one example, the N resources are in frequency domain. In one example, the N resources are in time domain and frequency domain. Wherein, N can be specified in the system specifications and/or configured or updated by RRC signaling and/or MAC CE signaling and/or L1 control (e.g., DCI Format) signaling. In one example, a different beam or spatial domain transmission filter can be used for each resource.

In one example, the N beams (spatial domain filter) used for transmission of the channel or signal conveying the first stage/part DL control information are related to or determined by the unified or indicated TCI state (for example Joint TCI state or the DL TCI state).

In one example, the UE monitors and decodes the N resources of the first stage/part control information mentioned herein. Based on the decoding and a signal quality associated with each of the N resources, the UE determines a preferred resource. In one example, the signal quality can be a reference signal received power (RSRP). In one example, the signal quality can be a signal-to-interference and noise ratio (SINR). In one example, a preferred resource can be a resource with the highest signal quality. In one example, a preferred resource can be a resource with signal quality above a threshold (a UE can select resource with signal quality above a threshold), wherein the threshold can be configured or updated by RRC signaling and/or MAC CE signaling and/or L1 control (e.g., DCI Format) signaling.

In one example, a UE can indicate a preferred resource in a feedback channel from the UE to the network. In one example, the feedback channel includes a bit field of size [log₂ N] that indicates a preferred resource. In one example, the feedback channel includes N resources, which can be in time domain and/or frequency domain and/or code domain (e.g., different scrambling codes), a UE can select a resource corresponding to the preferred resource of the first stage/part control information.

FIG. 37 illustrates a diagram of example first stage/part control information resources and feedback 3700 according to embodiments of the present disclosure. For example, first stage/part control information resources 3700 can be utilized by the UE 116 of FIG. 3. This example is for illustration only and other embodiments can be used without departing from the scope of the present disclosure.

In one example, the transmission of the feedback channel of the first stage/part control information can be repeated M times.
In one example, there are M feedback channel resources, wherein the UE transmits in each resource an ID corresponding to the preferred resource of the first stage/part control information. In one example, the M resources are in time domain. In one example, the M resources are in frequency domain. In one example, the M resources are in time domain and frequency domain. Wherein, M can be specified in the system specifications and/or configured or updated by RRC signaling and/or MAC CE signaling and/or L1 control (e.g., DCI Format) signaling. In one example, a different beam or spatial domain transmission filter can be used for each resource. In one example, M=1.
In one example, there are M×N feedback channel resources, for example, the channel resources are organized in N groups of M channel resources, a UE selects one of the N groups based on the preferred resource of the first stage/part control information. The M channel resources can be time domain and/or frequency domain. N groups can be in time domain and/or frequency domain and/or code domain (e.g., different scrambling codes). Wherein, M can be specified in the system specifications and/or configured or updated by RRC signaling and/or MAC CE signaling and/or L1 control (e.g., DCI Format) signaling. In one example, a different beam or spatial domain transmission filter can be used for each resource (of the M resources). In one example, M=1.

With reference to FIG. 37, an example with N=4 first stage/part control information resources in time domain and N×M=4×4 feedback channel resources is shown. The feedback channel resources have a dimension of N=4 in the frequency domain to indicate the one of the preferred resources of the first stage/part control information and dimension of M=4 in the time domain for repetition of the feedback channel.

In one example, the M beams (spatial domain filters) used for transmission of the feedback channel or signal in response to the first stage/part DL control information are related to or determined by the unified or indicated TCI state (for example Joint TCI state or the UL TCI state). In one example, a beam is selected at the UE for transmission of the feedback channel based on reciprocity between the UE reception and UE transmission.

In one example, the feedback signal or channel in response to the first stage/part control information includes or indicates information that controls subsequent transmissions and/or receptions at the UE or gNB.

In one example, the gNB monitors and decodes the one resource of the feedback signal or channel or M resources of the feedback signal or channel. Based on the decoding of the feedback signal or channel, the gNB determines information that controls subsequent transmissions and/or receptions at gNB. Based on the decoding and a signal quality associated with each of the M resources (when M resources are used), the gNB determines a preferred resource. In one example, the signal quality can be a reference signal received power (RSRP). In one example, the signal quality can be a signal-to-interference and noise ratio (SINR). In one example, a preferred resource can be a resource with the highest signal quality. In one example, a preferred resource can be a resource with signal quality above a threshold (a gNB/TRP can select resource with signal quality above a threshold), wherein the threshold can be configured or updated by RRC signaling and/or MAC CE signaling and/or L1 control signaling.

In one example, a gNB can indicate a preferred resource in a second stage/part control information from the network to the UE. In one example, the second stage/part control information includes a bit field of size [log₂ M] that indicates a preferred resource. In one example, the second stage/part control information can be transmitted in one of M resources, which can be in time domain and/or frequency domain and/or code domain (e.g., different scrambling codes), a gNB can select a resource corresponding to the preferred resource of the feedback signal or channel.

In one example, the beam (spatial domain transmission filter) used for the second stage/part control information (as illustrated in FIG. 30) and/or used for the DL shared channel (as illustrated in FIG. 30) and/or used for the channel that includes the second stage/part control information and the DL shared channel (as illustrated in FIG. 32) is determined based on the information included in or indicated by the feedback channel of the first stage/part control information.

In one example, the beam determined by the UE based on the reception and signal quality of the N resources used for the 1^{st} stage/part control information is used for subsequent transmission from the gNB to the UE and subsequent transmission from the UE to the gNB including one or more of:
second stage/part control information (as illustrated in FIG. 30).
DL shared channel (as illustrated in FIG. 30)
the channel that includes the second stage/part control information and the DL shared channel (as illustrated in FIG. 32)
The UL shared channel (as illustrated in FIG. 34)
The feedback signal or channel from the UE to the gNB (as illustrated in FIG. 31, FIG. 33 and FIG. 35).

In one example, the beam determined by the UE (e.g., the UE 116) based on the reception and signal quality of the N resources used for the 1^{st} stage/part control information is used for subsequent transmission from the gNB to the UE including one or more of:
second stage/part control information (as illustrated in FIG. 30).
DL shared channel (as illustrated in FIG. 30)
the channel that includes the second stage/part control information and the DL shared channel (as illustrated in FIG. 32)

In one example, the beam determined by the gNB based on the reception and signal quality of the M resources used for the feedback signal or channel of the 1^{st} stage/part control information is used for subsequent transmission from the UE to the gNB including one or more of:
The UL shared channel (as illustrated in FIG. 34)
The feedback signal or channel from the UE to the gNB (as illustrated in FIG. 31, FIG. 33 and FIG. 35).

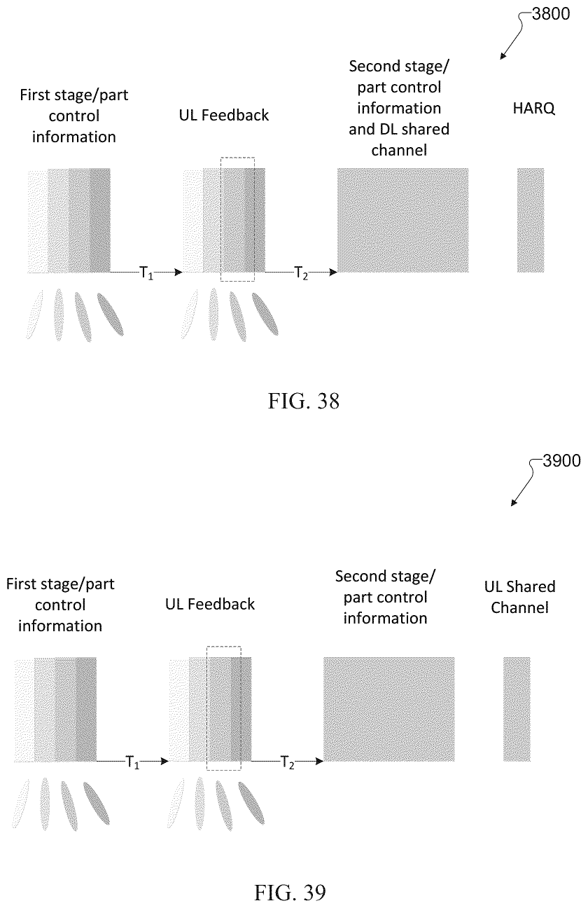

FIG. 38 illustrates an example timeline 3800 for a two stage DCI according to embodiments of the present disclosure. For example, timeline 3800 for a two stage DCI can be followed by any of the UEs 111-116 of FIG. 1, such as the UE 116 of FIG. 3. This example is for illustration only and other embodiments can be used without departing from the scope of the present disclosure.

With reference to FIG. 38, an example of two stage DL control for scheduling DL data is shown. The first stage/part control information is transmitted in N resources. The UE determines a preferred resource out of the N resources and indicates this in one of the UL feedback resources. A same beam (spatial domain filter) is used for the channel containing the second stage/part control information and the DL shared channel as well the channel conveying the HARQ feedback of the DL shared channel.

FIG. 39 illustrates an example timeline 3900 for a two stage DCI according to embodiments of the present disclosure. For example, timeline 3900 for a two stage DCI can be followed by any of the UEs 111-116 of FIG. 1, such as the UE 111. This example is for illustration only and other embodiments can be used without departing from the scope of the present disclosure.

With reference to FIG. 39, an example of two stage DL control for scheduling UL data is shown. The first stage/part control information is transmitted in N resources. The UE determines a preferred resource out of the N resources and indicates this in one of the UL feedback resources. A same beam (spatial domain filter) is used for the channel containing the second stage/part control information as well the channel conveying UL shared channel.

In one example, the time from first stage/part control information signal or channel and corresponding feedback signal or channel is T₁. In one example, T₁ is the time from the start of the signal or channel containing the first stage/part control information and start of the corresponding feedback signal(s) or channel(s) (the actual signal or channel or earliest signal or channel). In one example, T₁ is the time from the end of the signal or channel containing the first stage/part control information and start of the corresponding feedback signal(s) or channel(s) (the actual signal or channel or earliest signal or channel). In one example, T₁ is the time from the start of the signal or channel containing the first stage/part control information and end of the corresponding feedback signal(s) or channel(s) (the actual signal or channel or earliest signal or channel). In one example, T₁ is the time from the end of the signal or channel containing the first stage/part control information and end of the corresponding feedback signal(s) or channel(s) (the actual signal or channel or earliest signal or channel). In one example, T₁ depends on a sub-carrier spacing of the first stage/part control information channel or signal and/or the corresponding feedback channel or signal and/or second stage/part control information channel and/or signal and/or DL shared channel and/or UL shared channel. In one example, T₁ depends on smallest of the one or more of the sub-carrier spacings mentioned herein. In one example, T₁ depends on largest of the one or more of the sub-carrier spacings mentioned herein. In one example, T₁ starts and/or ends at a slot boundary, wherein the slot boundary is that of the smallest of the one or more of the sub-carrier spacings mentioned herein. In one example, T₁ starts and/or ends at a slot boundary, wherein the slot boundary is that of the largest of the one or more of the sub-carrier spacings mentioned herein. In one example, T₁ can be configured or updated by RRC signaling and/or MAC CE signaling and/or L1 control (e.g., DCI Format) signaling.

In one example, the time from feedback signal or channel in response to the first stage/part control information and the channel or signal conveying the second stage/part control information is T₂. In one example, T₂ is the time from the start of the feedback signal or channel in response to the first stage/part control information and start of the channel or signal conveying the second stage/part control information (the actual signal or channel or earliest signal or channel). In one example, T₂ is the time from the end of the feedback signal or channel in response to the first stage/part control information and start of the channel or signal conveying the second stage/part control information (the actual signal or channel or earliest signal or channel). In one example, T₂ is the time from the start of the feedback signal or channel in response to the first stage/part control information and end of the channel or signal conveying the second stage/part control information (the actual signal or channel or earliest signal or channel). In one example, T₂ is the time from the end of the feedback signal or channel in response to the first stage/part control information and end of the channel or signal conveying the second stage/part control information (the actual signal or channel or earliest signal or channel). In one example, T₂ depends on a sub-carrier spacing of the first stage/part control information channel or signal and/or the corresponding feedback channel or signal and/or second stage/part control information channel and/or signal and/or DL shared channel and/or UL shared channel. In one example, T₂ depends on smallest of the one or more of the sub-carrier spacings mentioned herein. In one example, T₂ depends on largest of the one or more of the sub-carrier spacings mentioned herein. In one example, T₂ starts and/or ends at a slot boundary, wherein the slot boundary is that of the smallest of the one or more of the sub-carrier spacings mentioned herein. In one example, T₂ starts or ends at a slot boundary, wherein the slot boundary is that of the largest of the one or more of the sub-carrier spacings mentioned herein. In one example, T₂ can be configured or updated by RRC signaling and/or MAC CE signaling and/or L1 control (e.g., DCI Format) signaling.

In one example, the container for first stage/part control information is a sequence that is determined or initialized at least by a UE's identity. Wherein, the UE identity can be configured by higher layers. In one example, the UE's identity is 16-bits. In one example, the UE's identity is 24-bits. In one example, the sequence is additionally determined or initialized by the information (payload) content of the first stage/part control information.

In one example, the container for first stage/part control information is a low power wake up signal (LP-WUS) that is determined or initialized at least by a UE's identity or part of the UE's identity.

In one example, the container for first stage/part control information is a physical channel (e.g., PDCCH) that carriers the payload of the first stage/part control information. The control information can have a CRC attached to it. In one example, the CRC is scrambled by UE's identity or RNTI. Wherein, the UE identity or RNTI can be configured by higher layers. In one example, the data can be further encoded and/or interleaved and/or rate-matched and mapped to resource element allocated to the first stage/part control information resource.

In one example, the container for feedback signal or channel in response to the first stage/part control information is a sequence. In one example, the sequence can be determined based on the identity of the identified or preferred resource of the first stage/part control information.

In one example, the container for feedback signal or channel in response to first stage/part control information is a physical channel (e.g., PUCCH or PUSCH) that carriers the payload of the first stage/part control information feedback. In one example, the channel includes a bit field determined based on the identity of the identified or preferred resource of the first stage/part control information.

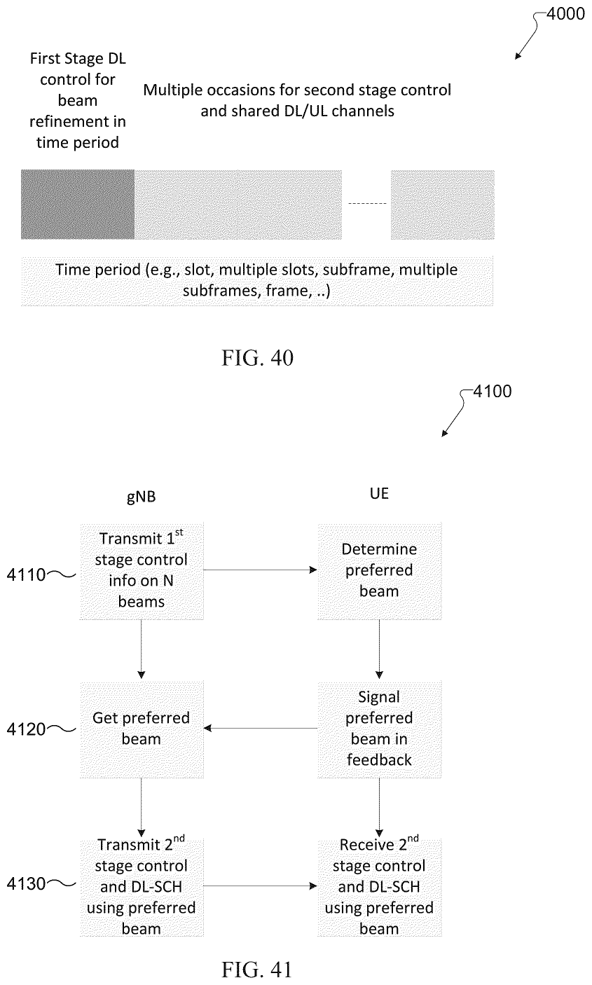

FIG. 40 illustrates a diagram of an example two-stage DCI 4000 according to embodiments of the present disclosure. For example, two-stage DCI 4000 can be received by any of the UEs 111-116 of FIG. 1, such as the UE 111. This example is for illustration only and other embodiments can be used without departing from the scope of the present disclosure.

FIG. 41 illustrates a flowchart of an example procedure 4100 for scheduling DL data using a two-stage DCI according to embodiments of the present disclosure. For example, procedure 4100 for scheduling DL data using a two-stage DCI can be performed by the UE 111 and the gNB 102 and/or network 130 in the wireless network 100 of FIG. 1. This example is for illustration only and other embodiments can be used without departing from the scope of the present disclosure.

The procedure begins in 4110, a gNB transmits to a UE the first stage control information on N beams. The UE then determines the preferred beam. In 4120, the UE signals to the gNB the preferred beam in feedback. In 4130, the gNB transmits to the UE the second stage control and DL-SCH using the preferred beam.

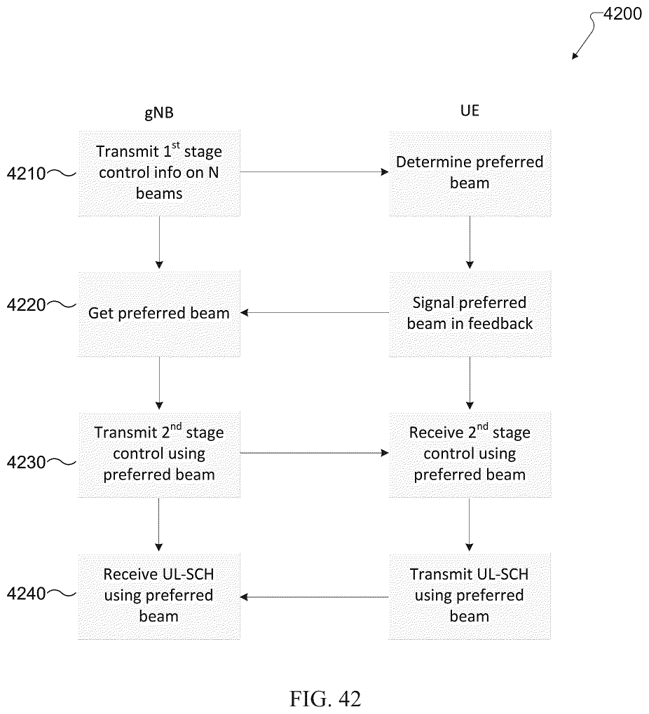

FIG. 42 illustrates a flowchart of an example procedure 4200 for scheduling UL data using a two-stage DCI according to embodiments of the present disclosure. For example, procedure 4200 for scheduling UL data using a two-stage DCI can be performed by the UE 116 and the gNB 102 and/or network 130 in the wireless network 100 of FIG. 1. This example is for illustration only and other embodiments can be used without departing from the scope of the present disclosure.

The procedure begins in 4210, a gNB transmits to a UE a first stage control information on N beams. The UE then determines a preferred beam. In 4220, after the UE signals to the gNB the preferred beam in feedback. In 4230, the gNB transmits to the UE a second stage control using the preferred beam. In 4240, the UE transmits to the gNB a UL-SCH using the preferred beam.

In one example, a first stage/part control information can be associated with multiple (e.g., K) second stage/part control information and/or DL/UL shared channels, if applicable, as illustrated in FIG. 40. Wherein, K can be specified in the system specifications and/or configured or updated by RRC signaling and/or MAC CE signaling and/or L1 control (e.g., DCI Format) signaling. In one example, the beam (spatial domain filter) indicated by a first stage/part control information is used for the next K instances of second stage/part control information and associated channels. In one example, the beam (spatial domain filter) indicated by a first stage/part control information is used for second stage/part control information and associated channels until the next occurrence of first stage/part control information.

With reference to FIG. 41, an example procedure for DL data scheduled using two stage control information is shown.

With reference to FIG. 42, an example procedure for UL data scheduled using two stage control information is shown.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information related to an operation with two-stage downlink (DL) control,
receive second information related to a control region for a first stage of the two-stage DL control, wherein the control region includes multiple resources, and
receive a first channel using N>=1 resources of the multiple resources, wherein the first channel includes a first control information; and
a processor operably coupled to the transceiver, the processor configured to determine, based on the first control information, (i) a resource allocation of a second channel and (ii) a size of a payload for the second channel,
wherein the transceiver is further configured to receive the second channel, and
wherein the second channel includes a second control information related to a second stage of the two-stage DL control.

2. The UE of claim 1, wherein:
the transceiver is further configured to receive third information for M payload sizes, and
the first control information indicates one of the M payload sizes.

3. The UE of claim 1, wherein:
the resource allocation of the second channel is a time offset from the control region, and
the time offset is indicated in the first control information.

4. The UE of claim 1, wherein the first control information indicates an identity of the UE to receive the second channel.

5. The UE of claim 1, wherein the transceiver is further configured to transmit an acknowledgment after reception of the first channel.

6. The UE of claim 5, wherein:
reception of the first channel includes N instances of the first channel,
the processor is further configured to determine a preferred instance of the N instances, and
the acknowledgment indicates the preferred instance.

7. The UE of claim 1, wherein:
the first control information includes a transmission configuration indication (TCI) state, and
the transceiver is further configured to apply the TCI state for reception of the second channel.

8. A base station (BS), comprising:
a transceiver configured to:
transmit first information related to an operation with two-stage downlink (DL) control, and
transmit second information related to a control region for a first stage of the two-stage DL control, wherein the control region includes multiple resources; and
a processor operably coupled to the transceiver, the processor configured to generate, a first control information including (i) a resource allocation of a second channel and (ii) a size of a payload for the second channel,
wherein the transceiver is further configured to transmit:
a first channel using N>=1 resources of the multiple resources, wherein the first channel includes the first control information, and
the second channel, and
wherein the second channel includes a second control information related to a second stage of the two-stage DL control.

9. The BS of claim 8, wherein:
the transceiver is further configured to transmit third information for M payload sizes, and
the first control information indicates one of the M payload sizes.

10. The BS of claim 8, wherein:
the resource allocation of the second channel is a time offset from the control region, and
the time offset is indicated in the first control information.

11. The BS of claim 8, wherein the first control information indicates an identity of a user equipment (UE) to receive the second channel.

12. The BS of claim 8, wherein the transceiver is further configured to receive an acknowledgment after reception of the first channel.

13. The BS of claim 12, wherein:
transmission of the first channel includes N instances of the first channel, and
the acknowledgment indicates a preferred instance of the N instances.

14. The BS of claim 8, wherein:
the first control information includes a transmission configuration indication (TCI) state, and
the transceiver is further configured to apply the TCI state for transmission of the second channel.

15. A method of operating a user equipment (UE), the method comprising:
receiving first information related to an operation with two-stage downlink (DL) control;
receiving second information related to a control region for a first stage of the two-stage DL control, wherein the control region includes multiple resources;
receiving a first channel using N>=1 resources of the multiple resources, wherein the first channel includes a first control information;
determining, based on the first control information, (i) a resource allocation of a second channel and (ii) a size of a payload for the second channel; and
receiving the second channel, wherein the second channel includes a second control information related to a second stage of the two-stage DL control.

16. The method of claim 15, further comprising:
receiving third information for M payload sizes,
wherein the first control information indicates one of the M payload sizes.

17. The method of claim 15, wherein:
the resource allocation of the second channel is a time offset from the control region, and
the time offset is indicated in the first control information.

18. The method of claim 15, further comprising transmitting an acknowledgment after reception of the first channel.

19. The method of claim 18, further comprising:
determining a preferred instance of N instances,
wherein reception of the first channel includes the N instances of the first channel, and
wherein the acknowledgment indicates the preferred instance.

20. The method of claim 15, wherein:
the first control information includes a transmission configuration indication (TCI) state, and
the method further comprises applying the TCI state for reception of the second channel.
